(19) United States
(12) Patent Application Publication
(10) Pub. No.: US 2024/0300525 A1
(43) Pub. Date: Sep. 12, 2024

(54) SYSTEMS AND METHODS RELATED TO CONTROLLING AUTONOMOUS VEHICLE(S)

(71) Applicant: Aurora Operations, Inc., Mountain View, CA (US)

(72) Inventors: James Andrew Bagnell, Pittsburgh, PA (US); Arun Venkatraman, Mountain View, CA (US); Sanjiban Choudhury, Pittsburgh, PA (US); Venkatraman Narayanan, Mountain View, CA (US)

(21) Appl. No.: 18/269,209

(22) PCT Filed: Dec. 17, 2021
(86) PCT No.: PCT/US2021/064022

§ 371 Date: Jun. 22, 2023

Related U.S. Application Data
(60) Provisional application No. 63/131,401, filed on Dec. 29, 2020.

(51) Int. Cl. B60W 60/00; G06N 20/00

(52) U.S. Cl. CPC B60W 60/001; G06N 20/00; B60W 2554/4026; B60W 2554/4029; B60W 2556/10

(57) ABSTRACT

Systems and methods related to controlling an autonomous vehicle (“AV”) are described herein. Implementations can process actor(s) from a past episode of locomotion of a vehicle, and stream(s) in an environment of the vehicle during the past episode to generate predicted output(s). The actor(s) may each be associated with a corresponding object in the environment of the vehicle, and the stream(s) may each represent candidate navigation paths in the environment of the vehicle. Further, implementations can process the predicted output(s) to generate further predicted output(s), and can compare the predicted output(s) to associated reference label(s). The processing can be performed utilizing layer(s) or distinct, additional layer(s) of machine learning (“ML”) model(s). Implementations can update the layer(s) or the additional layer(s) based on the comparing, and subsequently use the ML model(s) in controlling the AV.

### BACKGROUND

As computing and vehicular technologies continue to evolve, autonomy-related features have become more powerful and widely available, and capable of controlling vehicles in a wider variety of circumstances. For automobiles, for example, the automotive industry has generally adopted SAE International standard J3016, which designates 6 levels of autonomy. A vehicle with no autonomy is designated as Level 0, and with Level 1 autonomy, a vehicle controls steering or speed (but not both), leaving the operator to perform most vehicle functions. With Level 2 autonomy, a vehicle is capable of controlling steering, speed and braking in limited circumstances (e.g., while traveling along a highway), but the operator is still required to remain alert and be ready to take over operation at any instant, as well as to handle any maneuvers such as changing lanes or turning. Starting with Level 3 autonomy, a vehicle can manage most operating variables, including monitoring the surrounding environment, but an operator is still required to remain alert and take over whenever a scenario the vehicle is unable to handle is encountered. Level 4 autonomy provides an ability to operate without operator input, but only in specific conditions such as only certain types of roads (e.g., highways) or only certain geographical areas (e.g., specific cities for which adequate mapping data exists). Finally, Level 5 autonomy represents a level of autonomy where a vehicle is capable of operating free of operator control under any circumstances where a human operator could also operate.

The fundamental challenges of any autonomy-related technology relates to collecting and interpreting information about a vehicle's surrounding environment, along with making and implementing decisions to appropriately control the vehicle based on the current environment within which the vehicle is operating. Therefore, continuing efforts are being made to improve each of these aspects, and by doing so, autonomous vehicles increasingly are able to reliably handle a wider variety of situations and accommodate both expected and unexpected conditions within an environment.

### SUMMARY

As used herein, the term actor or track refers to an object in an environment of a vehicle during an episode (e.g., past or current) of locomotion of a vehicle (e.g., an AV, non-AV retrofitted with sensors, or a simulated vehicle). For example, the actor may correspond to an additional vehicle navigating in the environment of the vehicle, an additional vehicle parked in the environment of the vehicle, a pedestrian, a bicyclist, or other static or dynamic objects encountered in the environment of the vehicle. In some implementations, actors may be restricted to dynamic objects. Further, the actor may be associated with a plurality of features. The plurality of features can include, for example, velocity information (e.g., historical, current, or predicted future) associated with corresponding actor, distance information between the corresponding actor and each of a plurality of streams in the environment of the vehicle, pose information (e.g., location information and orientation information), or any combination thereof. In some implementations, the plurality of features may be specific to the corresponding actors. For example, the distance information may include a lateral distance or a longitudinal distance between a given actor and a closest object, and the velocity information may include the velocity of the given actor and the object along a given stream. In some additional or alternative implementations, the plurality of features may be relative to the AV. For example, the distance information may include a lateral distance or longitudinal distance between each of the plurality of actors and the AV, and the velocity information may include relative velocities of each of the actors with respect to the AV. As described herein, these features, which can include those generated by determining geometric relationships between actors, can be features that are processed using the ML model. In some implementations, multiple actors are generally present in the environment of the vehicle, and the actors can be captured in sensor data instances of sensor data generated by one or more sensors of the vehicle.

As used herein, the term stream refers to a sequence of poses representing a candidate navigation path, in the environment of the vehicle, for the vehicle or the actors. The streams can be one of a plurality of disparate types of streams. The types of streams can include, for example, a target stream corresponding to the candidate navigation path the vehicle is following or will follow within a threshold amount of time, a joining stream corresponding to any candidate navigation path that merges into the target stream, a crossing stream corresponding to any candidate navigation path that is transverse to the target stream, an adjacent stream corresponding to any candidate navigation path that is parallel to the target stream, an additional stream corresponding to any candidate navigation path that is one-hop from the joining stream, the crossing stream, or the adjacent stream, or a null stream that corresponds to actors in the environment that are capable of moving, but did not move in the past episode of locomotion (e.g., parked vehicle, sitting pedestrian, etc.) or to actors in the environment that are not following a given stream (e.g., pulling out of the driveway, erratic driving through an intersection, etc.). In some implementations, as the vehicle progresses throughout the environment, the target stream may dynamically change. As a result, each of the other types of streams in the environment may also dynamically change since they are each defined relative to the target stream.

As used herein, the term right-of-way refers to whether any given type of stream has priority over the target stream. There can be multiple types of right-of-way including, for example, a reported right-of-way and an inferred right-of-way. The reported right-of-way is based on traffic signs, traffic lights, traffic patterns, or any other explicit indicator that can be perceived in the environment of the vehicle (e.g., based on sensor data generated by one or more sensors of the vehicle), and that gives priority to the vehicle or an additional vehicle corresponding to an actor. For instance, the reported right-of-way can be based on a state of a given traffic light (i.e., red, yellow, green), a yield sign, a merging lane sign, and so on. In contrast with the reported right-of-way, the inferred right-of-way that is based on a state of the vehicle, or more particularly, a control state of the vehicle. For instance, the inferred right-of-way of the vehicle can indicate that the vehicle should yield to a merging vehicle if the merging vehicle is in front of the vehicle on a merging stream and if the vehicle is not accelerating.

As used herein, the term decider refers to a learned or engineered function that makes a corresponding decision with respect to an AV or a given actor. A plurality of different deciders can be utilized to make a plurality of distinct corresponding decisions based on a plurality of actors and a plurality of stream in an environment of the AV. For example, a yield decider can be utilized to determine whether the AV should yield, a merge decider can be utilized to determine whether the AV should yield, a joining stream decider can be utilized to determine whether a given actor is merging into a target stream of the AV, a crossing stream decider can be utilized to determine whether a given actor is crossing the target stream of the AV, and so on for a plurality of additional or alternative decisions. In some implementations, a plurality of actors and a plurality of streams can be processed, using one or more layers of a ML model, to generate predicted output associated with each of the plurality of actors. Further, the predicted output associated with each of the plurality of actors can be processed, using additional layers of one or more of the ML models, to make the corresponding decision. In these implementations, each of the deciders can correspond to the additional layers of one or more of the ML models, or a subset thereof. For example, the one or more additional layers may correspond to each of the deciders such that the output generated may include AV control strategies or AV control commands. In this example, the output need not be further processed to be utilized in controlling the AV. In contrast, first additional layers may correspond to a yield decider, second additional layers may correspond to a merge decider, third additional layers may correspond to a joining stream decider, and so on. In this example, the output of each of the individual deciders may be processed to rank or prune AV control strategies or AV control commands, and then a given AV control strategy or given AV control commands may be selected to be utilized in controlling the AV.

As used herein, the phrase episode of locomotion refers to an instance of a vehicle navigating through an environment autonomously, semi-autonomously, or non-autonomously. Driving data can be generated by sensors of the vehicle during the episode of locomotion. The driving data can include, for example, one or more actors captured during a given past episode of locomotion of a vehicle, and that are specific to the given past episode. As used herein, the phrase past episode of locomotion refers to a past instance of the vehicle navigating through the environment or another environment autonomously, semi-autonomously, or non-autonomously.

Consistent with one aspect of the invention, a method for training a machine learning (“ML”) model for use by an autonomous vehicle (“AV”) is described herein. The method may include: obtaining a plurality of actors for a past episode of locomotion of a vehicle, each of the plurality of actors corresponding to an object in an environment of the vehicle during the past episode; and obtaining a plurality of streams in the environment of the vehicle during the past episode, each of the plurality of streams representing a candidate navigation path, for the vehicle or the object corresponding to a given one of the actors, in the environment of the vehicle. The method may further include processing, using one or more ML layers of one or more of the ML models, the plurality of actors and the plurality of streams to generate predicted output for each of the plurality of actors; and processing, using one or more additional ML layers of one or more of the ML models, the predicted output for each of the plurality of actors to generate further predicted output for each of the plurality of streams and with respect to each of the plurality of actors. The method may further include generating, based on one or more reference labels for the past episode of locomotion and the further predicted output for each of the plurality of streams and with respect to each of the plurality of actors, one or more losses; and updating, based on the one or more losses, one or more of the additional ML model layers of one or more of the ML models. One or more of the additional ML model layers of one or more of the ML models are subsequently utilized in controlling the AV.

These and other implementations of technology disclosed herein can optionally include one or more of the following features.

In some implementations, the one or more additional layers may correspond to a plurality of disparate deciders, and the further predicted output may include an associated predicted decision made by each decider, of the plurality of disparate deciders, for each of the plurality of streams and with respect to each of the plurality of actors. In some versions of those implementations, the one or more reference labels may include an associated reference label, for each of the plurality of disparate deciders, that corresponds to a ground truth decision that is determined during the past episode of locomotion of the vehicle or that is defined for the vehicle subsequent to the past episode of locomotion of the vehicle. In some further versions of those implementations, generating one or more of the losses may include comparing the associated predicted decision made by each of the plurality of disparate deciders to the ground truth decision, for each of the plurality of deciders, to generate one or more of the losses, and updating the one or more additional ML model layers may include backpropagating one or more of the losses across the one or more additional ML model layers.

In some implementations, the one or more additional layers may correspond to a plurality of disparate deciders, and the further predicted output may include an associated predicted probability distribution, for each of the plurality of deciders, and for each of the plurality of streams with respect to each of the plurality of actors, that include a respective probability for a plurality of decisions associated with each of the plurality of disparate deciders. In some versions of those implementations, the one or more reference labels may include an associated reference label, for each of the plurality of disparate deciders, that corresponds to a ground truth probability distribution that is determined during on the past episode of locomotion of the vehicle or that is defined for the vehicle subsequent to the past episode of locomotion of the vehicle. In some further versions of those implementations, generating one or more of the losses may include comparing the associated predicted probability distribution to the ground truth probability distribution, for each of the plurality of deciders, to generate one or more of the losses, and updating the one or more additional ML model layers may include backpropagating one or more of the losses across the one or more additional ML model layers.

In some implementations, the further predicted output may include a predicted vehicle control strategy or predicted vehicle control commands. In some versions of those implementations, the one or more reference labels may include an associated reference label that corresponds to a ground truth vehicle control strategy or ground truth vehicle control commands that are determined during the past episode of locomotion of the vehicle or that is defined for the vehicle subsequent to the past episode of locomotion of the vehicle. In some further versions of those implementations, generating one or more of the losses may include comparing the predicted vehicle control strategy or the predicted vehicle control commands to the ground truth vehicle control strategy or the ground truth vehicle control commands to generate one or more of the losses, and updating the one or more additional ML model layers may include backpropagating one or more of the losses across the one or more additional ML model layers. In yet further versions of those implementations, each stream, of the plurality of streams, may correspond to a sequence of poses that represent the candidate navigation path, in the environment of the vehicle, for the vehicle or the object corresponding to a given one of the actors. In even further versions of those implementations, each stream, of the plurality of streams, may be at least one of: a target stream corresponding to the candidate navigation path the vehicle will follow, a joining stream that merges into the target stream, a crossing stream that is transverse to the target stream, an adjacent stream that is parallel to the target stream, or an additional stream that is one-hop from the joining stream, the crossing stream, or the adjacent stream.

In some implementations, the object corresponding to each of the one or more actors may be at least one of: an additional vehicle that is in addition to the vehicle, a bicyclist, or a pedestrian. In some versions of those implementations, the object may be dynamic in the environment of the vehicle along a particular stream of the plurality of streams.

In some implementations, subsequently utilizing one or more of the additional ML model layers of one or more of the ML models in controlling the AV may include processing, using the one or more ML model layers and the one or more additional ML model layers, sensor data generated by one or more sensors of the AV to predict an AV control strategy or predict AV control commands; and causing the AV to be controlled based on the predicted AV control strategy or the predicted AV control commands. In some versions of those implementations, the method may further include ranking a plurality of AV control strategies based on the processing, wherein the predicted AV control strategy is a highest ranked AV control strategy.

In some implementations, the one or more ML layers may include a first portion of a given one of the one or more ML models, and the one or more additional ML layers may include a second portion of the given one of the one or more ML models.

In some implementations, the one or more ML layers may include a first one of the one or more ML models, and wherein the one or more additional ML layers may include at least a second one of the one or more ML models.

Consistent with another aspect of the invention, a method for training one or more ML models for use by an AV is described herein. The method may include obtaining a plurality of training instances from a past episode of locomotion of a vehicle. Each of the plurality of training instances may include training instance input, the training instance input may include: predicted output generated using one or more ML model layers of one or more of the ML models, the predicted output being generated based on a plurality of actors and a plurality of streams, each of the plurality of actors corresponding to an object in an environment of the vehicle during the past episode, and each of the plurality of streams representing a candidate navigation path in the environment of the vehicle. Each of the plurality of training instances may further include training instance output, the training instance output may include one or more associated reference labels for the past episode of locomotion, each of the one or more associated reference labels corresponding to an action performed by the vehicle during the past episode of locomotion. The method may further include training one or more additional ML layers of one or more of the ML models based on the plurality of training instances. One or more of the additional ML model layers of one or more of the ML models may be subsequently utilized in controlling the AV.

Consistent with yet another aspect of the invention, a method for using one or more trained ML models by an AV is described herein. The method may include receiving a sensor data instance of sensor data generated by one or more sensors of the AV, the sensor data instance being captured at a given time instance, and identifying, based on the sensor data instance, a plurality of actors in an environment of the AV. Each actor, of the plurality of actors, may correspond to an associated object in the environment of the AV. The method may further include identifying, based on the plurality of actors in the environment of the AV, a plurality of streams associated with one or more of the plurality of actors. Each stream, of the plurality of streams, may correspond to a candidate navigation path for the AV or the associated object corresponding to one of the plurality of actors. The method may further include processing, in parallel, and using one or more ML layers of one or more of the trained ML models, the plurality of actors and the plurality of streams to generate output, processing, using one or more additional ML layers of one or more of the trained ML models, the output to generate further output, and causing the AV to be controlled based on the further output generated using one or more of the additional ML layers of one or more of the trained ML models.

These and other implementations of technology disclosed herein can optionally include one or more of the following features.

In some implementations, the one or more additional ML layers of one or more of the trained ML models may correspond to an associated one of a plurality of disparate deciders, and the further output may include an associated decision made by each decider, of the plurality of disparate deciders, for each of the plurality of streams and with respect to each of the plurality of actors. In some versions of those implementations, the method may further include obtaining, from one or more databases, a list of AV control strategies or AV control commands. In some further versions of those implementations, the method may further include ranking the AV control strategies or the AV control commands, included in the list, based on the associated decision made by each of the plurality of disparate deciders. In those implementations, causing the AV to be controlled based on the further output generated using one or more of the additional ML layers of one or more of the trained ML models may include causing the AV to be controlled based on a highest ranked AV control strategy or highest ranked AV control commands. In some additional or alternative implementations, the method may further include pruning the AV control strategies or the AV control commands, from the list, based on the associated decision made by each of the plurality of disparate deciders. In those implementations, causing the AV to be controlled based on the further output generated using one or more of the additional ML layers of one or more of the trained ML models may include causing the AV to be controlled based on a remaining ranked AV control strategy or remaining AV control commands.

In some implementations, the further output may include an AV control strategy or AV control commands, and causing the AV to be controlled based on the further output generated using one or more of the additional ML layers of one or more of the trained ML models may include causing the AV to be controlled based on the AV control strategy or AV control commands. In some versions of those implementations, the AV control strategy may include at least one of: a yield strategy, a merge strategy, a turning strategy, a traffic light strategy, an accelerating strategy, a decelerating strategy, or a constant velocity strategy. In some additional or alternative versions of those implementations, the AV control commands may include a magnitude corresponding to at least one of: a velocity component, an acceleration component, a deceleration component, or a steering component.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), tensor processing unit(s) (TPU(s), or any combination thereof) to perform a method such as one or more of the methods described herein. Other implementations can include a system of one or more servers that include one or more processors operable to execute stored instructions to perform a method such as one or more of the methods described herein. Yet other implementations can include non-transitory computer-readable mediums storing instructions that, when executed, cause one or more processors operable to execute operations according to a method such as one or more of the methods described herein.

The above description is provided as an overview of some implementations of the present disclosure. Further description of those implementations, and other implementations, are described in more detail below.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example hardware and software environment for an autonomous vehicle, in accordance with various implementations.

FIG. 2A is a block diagram illustrating an example training architecture for training machine learning layers of machine learning model(s), in accordance with various implementations.

FIG. 2B is a block diagram illustrating an example training architecture for training additional machine learning layers of the machine learning model(s) of FIG. 2A, in accordance with various implementations.

FIGS. 3A and 3B illustrate an example environment from a past episode of locomotion of a vehicle that is utilized in training the layers of the machine learning model(s) of FIG. 2A, and the additional layers of the machine learning model(s) of FIG. 2B, in accordance with various implementations.

FIGS. 4A, 4B, and 4C are block diagrams illustrating example architectures for using the trained layers of the machine learning model(s) of FIG. 2A, and the trained additional layers of the machine learning model(s) of FIG. 2B in controlling an autonomous vehicle, in accordance with various implementations.

FIG. 5 is a flowchart illustrating an example method of training additional layers of machine learning model(s), in accordance with various implementations.

FIG. 6 is a flowchart illustrating an example method of generating further predicted outputs in training the additional layers of the machine learning model(s) for the example method of FIG. 5, in accordance with various implementations.

FIG. 7 is a flowchart illustrating an example method of using layers of trained machine learning model(s) and additional layers of machine learning model(s) of FIG. 6, in accordance with various implementations.

### DETAILED DESCRIPTION

The present disclosure is directed to particular method(s) or system(s) for training one or more machine learning (“ML”) models for use in controlling an autonomous vehicle (“AV”), or the use thereof. Various implementations described herein relate to training one or more of the ML models, based on past episodes of locomotion of a vehicle, to predict AV control strategies or AV control commands the AV should implement in an environment. The past episode of locomotion may be captured in driving data generated by the vehicle during driving of the vehicle or by other sensors in the environment during the driving of the vehicle. In some implementations, the driving data that captures the past episode can include manual driving data that is captured while a human is driving the vehicle (e.g., an AV or non-AV retrofitted with sensors) in a real environment and in a conventional mode, where the conventional mode represents the vehicle under active physical control of a human operating the vehicle. In other implementations, the driving data that captures the past episode can be autonomous driving data that is captured while the vehicle (e.g., an AV) is driving in a real environment and in an autonomous mode, where the autonomous mode represents the AV being autonomously controlled. In yet other implementations, the driving data that captures the past episode can be simulated driving data captured while a virtual human is driving the vehicle (e.g., a virtual vehicle) in a simulated world.

In some implementations, a plurality of actors can be identified, from the driving data, at a given time instance of the past episode of locomotion. The plurality of actors may each correspond to an additional object in the environment of the vehicle during the past episode of locomotion, and may each be associated with a plurality of features. The plurality of features can include, for example, at least one of: velocity information associated with the object corresponding to each of the plurality of actors; distance information associated with the object corresponding to each of the plurality of actors; or pose information associated with the object corresponding to each of the plurality of actors. Further, a plurality of streams can be identified in the environment of the vehicle. The plurality of streams may each correspond to a sequence of poses that represent a candidate navigation path in the environment of the vehicle. For example, a first stream can be a first candidate navigation path for a first actor, a second stream can be a second candidate navigation path for the first actor, a third stream can be a candidate navigation path for the vehicle (e.g., the currently planned navigation path), etc.

The plurality of actors and the plurality of streams can be processed, using the layers of one or more of the ML models, to generate predicted output(s). For example, the plurality of actors and the plurality of streams, from the given time instance of the past episode, can be processed, in parallel, using layers of one or more of the ML models. In processing the plurality of actors and the plurality of streams, the layers of one or more of the ML models are trained to project features of each of the plurality actors onto each of the plurality of streams in the environment of the AV. This enables layers of one or more of the ML models, through training, to be usable to leverage the features of each of the plurality of actors to determine geometric relationships between each of the plurality of actors and each of the plurality of streams. For example, these features can include those generated by determining geometric relationships between actors and the AV, can be features that are processed using the layers of one or more of the ML models, and can be also usable to forecast navigation paths of the actors in the environment of the AV.

In some implementations, the predicted output(s) include a probability distribution for each of the plurality of actors. The probability distributions for the plurality of actors can include a respective probability, for each of the plurality of streams, that the object corresponding to the actor will follow the stream at a subsequent time instance of the past episode of locomotion based on the plurality of actors and streams at the given time instance of the past episode. In some additional or alternative implementations, the predicted output(s) can include one or more predicted actions that the vehicle should perform at the given time instance, or a subsequent time instance, of the past episode based on the plurality of actors and streams at the given time instance of the past episode. For example, the one or more predicted actions can include whether the vehicle should yield, whether the vehicle should perform a turning action at an intersection, whether the vehicle should perform a merging action into a different lane of traffic, etc. In some additional or alternative implementations, the predicted output(s) can include one or more constraints for the vehicle at the given time instance, or subsequent time instance, of the past episode based on the plurality of actors and streams at the given time instance of the past episode. For example, the constraints can indicate locations, in the environment of the vehicle, where the vehicle should not be at the given time instance or the subsequent time instance. In other words, the constraints allow the objects corresponding to the actors to navigate in the environment of the vehicle without the vehicle interfering with the navigation paths of the objects.

In training additional layers of one or more of the ML models, the predicted output(s) may be considered training instance input for a given training instance, and corresponding ground truth label(s) (or reference label(s)) may be considered training instance output for the given training instance. Further, when training the additional layers of one or more of the ML models, these predicted output(s) may be generated for each training instance, retrieved from one or more databases for each training instance, or any combination thereof. In various implementations, the predicted output(s) can be processed, using additional layers one or more of the ML models, to generate further predicted output(s). The layers that process the plurality of actors and the plurality of streams, and the additional layers that process the predicted output(s) can be portions of the same ML model (e.g., end-to-end), portions of distinct ML models, or portions of multiple distinct ML models. For example, the layers utilized to generate the predicted output(s) based on the actor(s) and the stream(s) can be a first portion of a given ML model, and the additional layers utilized to generate the further predicted output(s) based on the predicted output(s) can be a second portion of the given ML model. As another example, the layers utilized to generate the predicted output(s) based on the actor(s) and the stream(s) can be a portion of a ML model, and the additional layers utilized to generate the further predicted output(s) based on the predicted output(s) can be a portion an additional ML model. As yet another example, the layers utilized to generate the predicted output(s) based on the actor(s) and the stream(s) can be a portion of a ML model, and the additional layers utilized to generate the further predicted output(s) based on the predicted output(s) can be a portion of a first additional ML model, a portion of second additional ML model, and so on.

In some versions of those implementations, the additional layers of one or more of the ML models can correspond to a plurality of disparate deciders. In some further versions of those implementations, the further predicted output(s) can correspond to a corresponding predicted decision made by each of the plurality of disparate deciders. For example, first additional layers may correspond to a yield decider that is utilized to determine whether the AV should yield (e.g., yield or don't yield), second additional layers may correspond to a merge decider that is utilized to determine whether the AV should merge (e.g., merge or don't merge), third additional layers may correspond to a joining stream decider that is utilized to determine whether a given actor is merging into a target stream of the AV (e.g., will merge or won't merge), and so on. In some implementations, each of the plurality of disparate deciders can process the predicted output(s) generated based on processing the plurality of actors and the plurality of streams. Further, the additional layers corresponding to the plurality of disparate deciders can correspond to portions of the same ML model, portions of distinct ML models, or portions of multiple distinct ML models as described above. Accordingly, each of the plurality of disparate deciders can make the corresponding decision based on the predicted output(s) that are generated based on the plurality of actors and the plurality of streams. In these implementations, the corresponding predicted decision from each of the plurality deciders can be compared to the corresponding ground truth label(s) to generate losses, and the losses can be utilized to update the additional layers corresponding to a respective one of the plurality of deciders. For example, the corresponding ground truth label(s) can correspond to a ground truth decision made by the vehicle (e.g., to yield) during the past episode of locomotion, or defined for the vehicle subsequent to the past episode of locomotion, to generate losses for each of the plurality of disparate deciders, and losses can be backpropagated across the respective additional layers. In this manner, the additional layers of one or more of the ML models can be trained.

In other further versions of those implementations, the further predicted output(s) can correspond to a corresponding predicted probability distribution associated with the corresponding decision made by each of the plurality of disparate deciders. For example, first additional layers may correspond to a yield decider that is utilized to determine a first probability distribution associated with whether the AV should yield (e.g., 0.8 for yield and 0.2 for don't yield), second additional layers may correspond to a merge decider that is utilized to determine a second probability distribution associated with whether the AV should merge (e.g., 0.6 for merge and 0.4 for don't merge), third additional layers may correspond to a joining stream decider that is utilized to determine a third probability distribution associated with whether a given actor is merging into a target stream of the AV (e.g., 0.5 will merge and 0.5 won't merge), and so on. In these implementations, the corresponding predicted probability distribution from each of the plurality deciders can be compared to the corresponding ground truth label(s) to generate losses, and the losses can be utilized to update the additional layers corresponding to a respective one of the plurality of deciders. For example, the corresponding ground truth label(s) can correspond to a ground truth probability distribution associated with a decision made by the vehicle (e.g., 1.0 for yield, and 0.0 for don't yield) during the past episode of locomotion, or defined for the vehicle subsequent to the past episode of locomotion, to generate losses for each of the plurality of disparate deciders, and losses can be backpropagated across the respective additional layers. In this manner, the additional layers of one or more of the ML models can be trained.

In yet further versions of these implementations, each corresponding decision made by each of the plurality of disparate deciders can be utilized to prune or rank AV control strategies or AV control strategies from a list of AV control strategies or AV control commands. The list of AV control strategies can be stored in one or more databases, and can include, for example, a yield strategy, a merge strategy, a turning strategy, a traffic light strategy, an accelerating strategy, a decelerating strategy, or a constant velocity strategy. Additionally or alternatively, the list of AV control commands can also be stored in one or more databases, and can include, for example, a magnitude corresponding to one or more of a velocity component, an acceleration component, a deceleration component, or a steering component. For example, if output from a traffic light decider indicates that the AV should proceed into the intersection, but output from a pedestrian decider indicates the AV should yield to a pedestrian that has entered the intersection, then an accelerating strategy can be pruned from the list of AV control strategies, or any AV control commands that have a magnitude corresponding to an acceleration component can be pruned from the list of AV control commands. As another example, if output from a traffic light decider indicates that the AV should proceed into the intersection, but output from a pedestrian decider indicates the AV should yield to a pedestrian that has entered the intersection, then an accelerating strategy can be demoted in a ranked list of AV control strategies, or any AV control commands that have a magnitude corresponding to an acceleration component can be demoted in the ranked list of AV control commands, and AV control strategies or AV control commands associated with decelerating or yielding to the pedestrian can be promoted. A remaining AV control strategy or remaining AV control commands, or a highest ranked AV control strategy or highest rank AV control commands, can be selected for utilization in controlling the AV. In these implementations, the selected AV control strategy of AV control commands can be compared to the corresponding ground truth label(s) to generate losses, and the losses can be utilized to update the additional layers corresponding to a respective one of the plurality of deciders. For example, the corresponding ground truth label(s) can correspond to a ground truth AV control strategy or ground truth AV control commands from the past episode of locomotion, or defined for the vehicle subsequent to the past episode of locomotion, to generate losses for each of the plurality of disparate deciders, and losses can be backpropagated across the respective additional layers. In this manner, the additional layers of one or more of the ML models can be trained.

In some additional or alternative implementations, the additional layers of one or more of the ML models can be a proxy for the plurality of disparate deciders, and the further predicted output(s) can correspond to an AV control strategy or AV control commands. In other words, the plurality of disparate deciders may be omitted, and the output generated by processing the predicted output(s) may directly indicate the AV control strategy or AV control commands. Further, the AV control strategy or AV control commands generated based on the predicted output(s) can include a pruned list or ranked list of the AV control strategies or AV control commands. Moreover, a remaining AV control strategy or AV control commands, or highest ranked AV control strategy or AV control commands can be selected for utilization in controlling the AV. In these implementations, the selected AV control strategy of AV control commands can be compared to the corresponding ground truth label(s) to generate losses, and the losses can be utilized to update the additional layers in a similar manner described above.

Subsequent to training the additional layers of one or more of the ML model, the additional layers can be utilized in controlling the AV during a current episode of locomotion. For example, a sensor data instance of sensor data generated by one or more sensors of the AV can be received. The sensor data can be processed to identify a plurality of actors in an environment of the AV, and a plurality of streams can be identified based on the environment of the AV, or the identified actors in the environment. Further, the plurality of actors and the plurality of streams (e.g., various features based thereon) can be processed, using the layers of one or more of the ML models, to generate output. The generated output can be further processed by the additional layers of one or more of the ML models to generate further output. In some implementations, the further output can include a corresponding decision made by the plurality of deciders that processed the generated output, and the further output can include AV control strategies or AV control commands. The AV control strategies or AV control commands can be ranked in a list, or pruned from the list, based on the corresponding decisions made by each of the plurality of disparate deciders as described above. In other implementations, the further output can directly indicate the AV control strategies or AV control commands that are to be utilized in controlling the AV.

Prior to further discussion of these and other implementations, however, an example hardware and software environment that the various techniques disclosed herein may be implemented will be discussed.

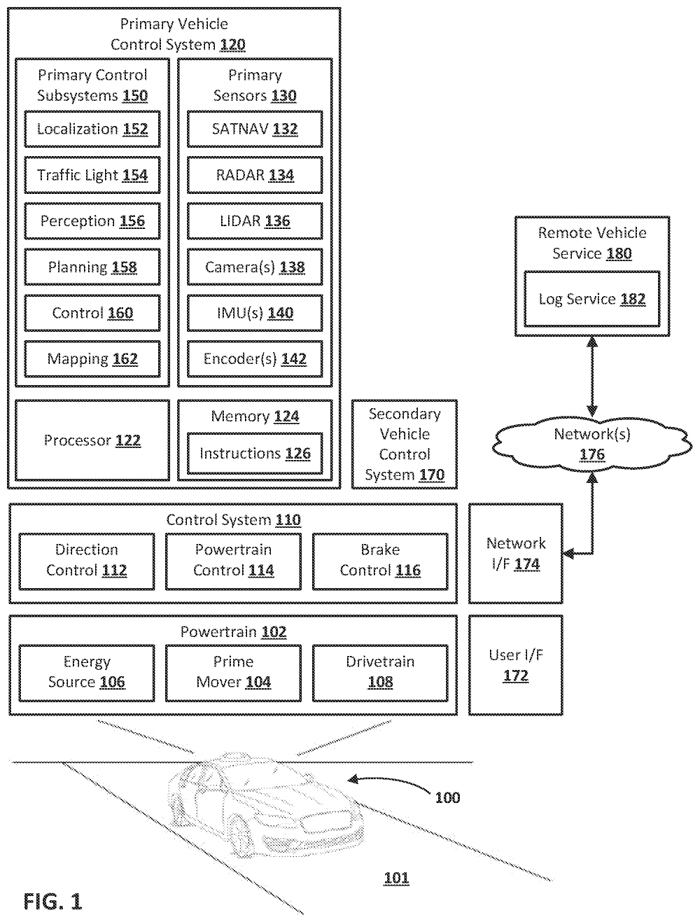

Turning to the drawings, wherein like numbers denote like parts throughout the several views, FIG. 1 illustrates an example autonomous vehicle 100 that the various techniques disclosed herein may be implemented. Vehicle 100, for example, is shown driving on a road 101, and vehicle 100 may include powertrain 102 including prime mover 104 powered by energy source 106 and capable of providing power to drivetrain 108, as well as control system 110 including direction control 112, powertrain control 114 and brake control 116. Vehicle 100 may be implemented as any number of different types of vehicles, including vehicles capable of transporting people or cargo, and it will be appreciated that the aforementioned components 102-116 can vary widely based upon the type of vehicle that these components are utilized.

The implementations discussed hereinafter, for example, will focus on a wheeled land vehicle such as a car, van, truck, bus, etc. In such implementations, prime mover 104 may include one or more electric motors or an internal combustion engine (among others), while energy source 106 may include a fuel system (e.g., providing gasoline, diesel, hydrogen, etc.), a battery system, solar panels or other renewable energy source, a fuel cell system, etc., and the drivetrain 108 may include wheels or tires along with a transmission or any other mechanical drive components suitable for converting the output of prime mover 104 into vehicular motion, as well as one or more brakes configured to controllably stop or slow the vehicle and direction or steering components suitable for controlling the trajectory of the vehicle (e.g., a rack and pinion steering linkage enabling one or more wheels of vehicle 100 to pivot about a generally vertical axis to vary an angle of the rotational planes of the wheels relative to the longitudinal axis of the vehicle). In some implementations, combinations of powertrains and energy sources may be used, e.g., in the case of electric/gas hybrid vehicles, and in various instances multiple electric motors (e.g., dedicated to individual wheels or axles) may be used as a prime mover. In the case of a hydrogen fuel cell implementation, the prime mover may include one or more electric motors and the energy source may include a fuel cell system powered by hydrogen fuel.

Direction control 112 may include one or more actuators or sensors for controlling and receiving feedback from the direction or steering components to enable the vehicle to follow a desired trajectory. Powertrain control 114 may be configured to control the output of powertrain 102, e.g., to control the output power of prime mover 104, to control a gear of a transmission in drivetrain 108, etc., thereby controlling a speed or direction of the vehicle. Brake control 116 may be configured to control one or more brakes that slow or stop vehicle 100, e.g., disk or drum brakes coupled to the wheels of the vehicle.

Other vehicle types, including but not limited to off-road vehicles, all-terrain or tracked vehicles, construction equipment, etc., will necessarily utilize different powertrains, drivetrains, energy sources, direction controls, powertrain controls and brake controls, as will be appreciated by those of ordinary skill having the benefit of the instant disclosure. Moreover, in some implementations various components may be combined, e.g., where directional control of a vehicle is primarily handled by varying an output of one or more prime movers. Therefore, the invention is not limited to the particular application of the herein-described techniques in an autonomous wheeled land vehicle.

In the illustrated implementation, autonomous control over vehicle 100 (including degrees of autonomy as well as selectively autonomous functionality) may be implemented in a primary vehicle control system 120 that may include one or more processors 122 and memory 124, with processors 122 configured to execute program code instructions 126 stored in memory 124.

Primary sensor system 130 may include various sensors suitable for collecting information from a vehicle's surrounding environment for use in controlling the operation of the vehicle. For example, satellite navigation (SATNAV) sensor 132, e.g., compatible with any of various satellite navigation systems such as GPS, GLONASS, Galileo, Compass, etc., may be used to determine the location of the vehicle on the Earth using satellite signals. Radio Detection and Ranging (RADAR) and Light Detection and Ranging (LIDAR) sensors 134, 136, as well as a camera(s) 138 (including various types of vision components capable of capturing still or video imagery), may be used to sense stationary and moving objects within the immediate vicinity of a vehicle. Inertial measurement unit (IMU) 140 may include multiple gyroscopes and accelerometers capable of detection linear and rotational motion of a vehicle in three directions, while wheel encoder(s) 142 may be used to monitor the rotation of one or more wheels of vehicle 100.

The outputs of sensors 132-142 may be provided to a set of primary control subsystems 150, including, localization subsystem 152, traffic light subsystem 154, perception subsystem 156, planning subsystem 158, control subsystem 160, and a mapping subsystem 162. Localization subsystem 152 may determine the location and orientation (also sometimes referred to as “pose” that may also include one or more velocities or accelerations) of vehicle 100 within its surrounding environment, and generally within a particular frame of reference. As will be discussed in greater detail herein, traffic light subsystem 154 may identify intersections and traffic light(s) associated therewith, and process a stream of vision data corresponding to images of the traffic light(s) to determine a current state of each of the traffic light(s) of the intersection for use by planning, control, and mapping subsystems 158-162, while perception subsystem 156 may detect, track, or identify elements within the environment surrounding vehicle 100.

In some implementations, traffic light subsystem 154 may be a subsystem of perception subsystem 156, while in other implementation, traffic light subsystem is a standalone subsystem. Control subsystem 160 may generate suitable control signals for controlling the various controls in control system 110 in order to implement the planned path of the vehicle. In addition, mapping subsystem 162 may be provided in the illustrated implementations to describe the elements within an environment and the relationships therebetween. Further, mapping subsystem 162 may be accessed by the localization, traffic light, planning, and perception subsystems 152-158 to obtain information about the environment for use in performing their respective functions. Moreover, mapping subsystem 162 may interact with remote vehicle service 180, over network(s) 176 via a network interface (network I/F) 174.

It will be appreciated that the collection of components illustrated in FIG. 1 for primary vehicle control system 120 is merely exemplary in nature. Individual sensors may be omitted in some implementations, multiple sensors of the types illustrated in FIG. 1 may be used for redundancy or to cover different regions around a vehicle, and other types of sensors may be used. Likewise, different types or combinations of control subsystems may be used in other implementations. Further, while subsystems 152-162 are illustrated as being separate from processors 122 and memory 124, it will be appreciated that in some implementations, portions or all of the functionality of subsystems 152-162 may be implemented with program code instructions 126 resident in memory 124 and executed by one or more of processors 122. Further, these subsystems 152-162 may in some instances be implemented using the same processors or memory, while in other instances may be implemented using different processors or memory. Subsystems 152-162 in some implementations may be implemented at least in part using various dedicated circuit logic, various processors, various field-programmable gate arrays (“FPGA”), various application-specific integrated circuits (“ASIC”), various real time controllers, and the like, and as noted above, multiple subsystems may utilize common circuitry, processors, sensors, or other components. Further, the various components in primary vehicle control system 120 may be networked in various manners.

In some implementations, vehicle 100 may also include a secondary vehicle control system 170 that may be used as a redundant or backup control system for vehicle 100. In some implementations, secondary vehicle control system 170 may be capable of fully operating vehicle 100 in the event of an adverse event in primary vehicle control system 120, while in other implementations, secondary vehicle control system 170 may only have limited functionality, e.g., to perform a controlled stop of vehicle 100 in response to an adverse event detected in primary vehicle control system 120. In still other implementations, secondary vehicle control system 170 may be omitted.

In general, an innumerable number of different architectures, including various combinations of software, hardware, circuit logic, sensors, networks, etc. may be used to implement the various components illustrated in FIG. 1. The processors 122 may be implemented, for example, as central processing unit(s) (CPU(s)), graphics processing unit(s) (GPU(s)), tensor processing unit(s) (TPU(s)), or any combination thereof, and portions of memory 124 may represent random access memory (RAM) devices comprising a main storage, as well as any supplemental levels of memory, e.g., cache memories, non-volatile or backup memories (e.g., programmable or flash memories), read-only memories, etc. In addition, the portions of memory 124 may be considered to include memory storage physically located elsewhere in vehicle 100, e.g., any cache memory in a processor, as well as any storage capacity used as a virtual memory, e.g., as stored on a mass storage device or on another computer or controller. One or more of processors 122 illustrated in FIG. 1, or entirely separate processors, may be used to implement additional functionality in vehicle 100 outside of the purposes of autonomous control, e.g., to control entertainment systems, to operate doors, lights, convenience features, etc.

In addition, for additional storage, vehicle 100 may also include one or more mass storage devices, e.g., a floppy or other removable disk drive, a hard disk drive, a direct access storage device (DASD), an optical drive (e.g., a CD drive, a DVD drive, etc.), a solid state storage drive (SSD), network attached storage, a storage area network, or a tape drive, among others. Furthermore, vehicle 100 may include a user interface 172 to enable vehicle 100 to receive a number of inputs from and generate outputs for a user or operator, e.g., one or more displays, touchscreens, voice or gesture interfaces, buttons and other tactile controls, etc. Otherwise, user input may be received via another computer or electronic device, e.g., via an app on a mobile device or via a web interface, e.g., from a remote operator.

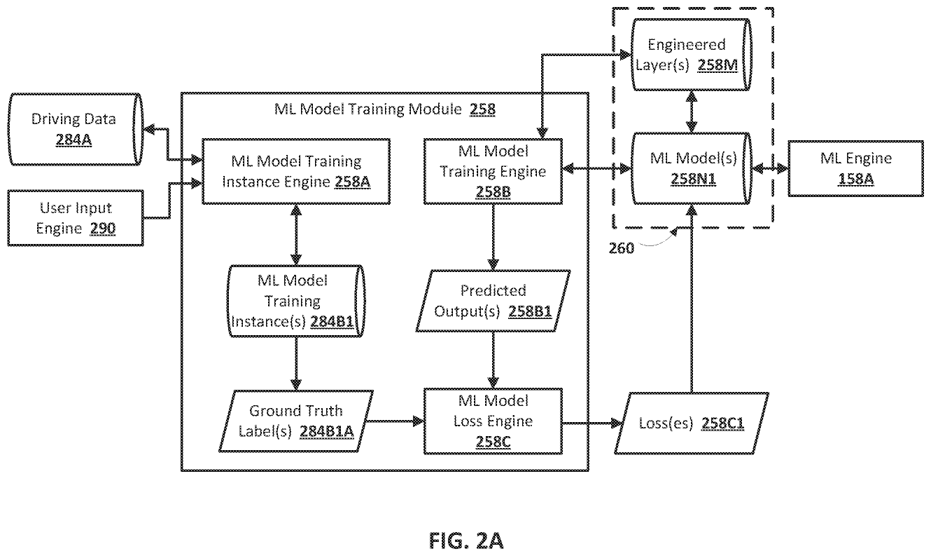

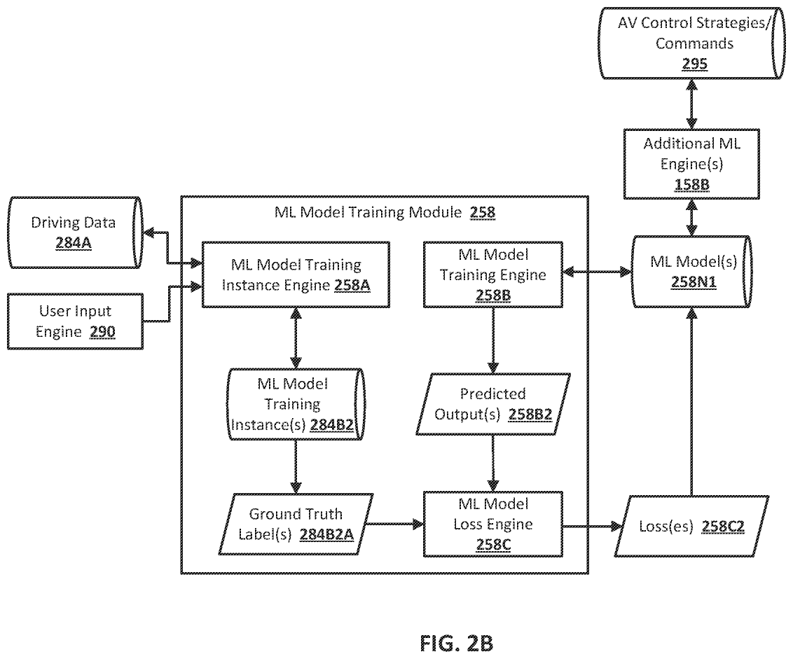

Moreover, vehicle 100 may include one or more network interfaces, e.g., network interface 174, suitable for communicating with network(s) 176 (e.g., a LAN, a WAN, a wireless network, Bluetooth, or the Internet, among others) to permit the communication of information with other vehicles, computers, or electronic devices, including, for example, a central service, such as a cloud service that vehicle 100 may receive environmental and other data for use in autonomous control thereof. In the illustrated implementations, for example, vehicle 100 may be in communication with a cloud-based remote vehicle service 180 including, at least for the purposes of implementing various functions described herein, a log service 182. Log service 182 may be used, for example, to collect or analyze driving data from past episodes of locomotion, of one or more autonomous vehicles during operation (i.e., during manual operation or autonomous operation), of one or more other non-autonomous vehicles retrofitted with one or more of the sensors described herein (e.g., one or more of primary sensors 130), or of simulated driving of a vehicle. Using the log service 182 enables updates to be made to the global repository, as well as for other offline purposes such as training machine learning model(s) for use by vehicle 100 (e.g., as described in detail herein with respect to FIG. 2).

The processors 122 illustrated in FIG. 1, as well as various additional controllers and subsystems disclosed herein, generally operates under the control of an operating system and executes or otherwise relies upon various computer software applications, components, programs, objects, modules, data structures, etc., as will be described in greater detail herein. Moreover, various applications, programs, objects, modules, or other components may also execute on one or more processors in another computer coupled to vehicle 100 via network(s) 176, e.g., in a distributed, cloud-based, or client-server computing environment, whereby the processing required to implement the functions of a computer program may be allocated to multiple computers or services over a network. Further, in some implementations data recorded or collected by a vehicle may be manually retrieved and uploaded to another computer or service for analysis.

In general, the routines executed to implement the various implementations described herein, whether implemented as part of an operating system or a specific application, component, program, object, module or sequence of instructions, or even a subset thereof, will be referred to herein as “program code.” Program code typically comprises one or more instructions that are resident at various times in various memory and storage devices, and that, when read and executed by one or more processors, perform the steps necessary to execute steps or elements embodying the various aspects of the invention. Moreover, while the invention has and hereinafter will be described in the context of fully functioning computers and systems, it will be appreciated that the various implementations described herein are capable of being distributed as a program product in a variety of forms, and that the invention applies equally regardless of the particular type of computer readable media used to actually carry out the distribution. Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.), among others.

In addition, various program codes described hereinafter may be identified based upon the application that it is implemented within in a specific implementation. However, it should be appreciated that any particular program nomenclature that follows is used merely for convenience, and thus the invention should not be limited to use solely in any specific application identified or implied by such nomenclature. Furthermore, based on the typically endless number of manners that computer programs may be organized into routines, procedures, methods, modules, objects, and the like, as well as the various manners that program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware or software environments may be used without departing from the scope of the invention.

Turning now to FIG. 2A, a block diagram illustrating an example training architecture for training machine learning (“ML”) layers of ML model(s) that is used by a planning subsystem (e.g., planning subsystem 158) of an autonomous vehicle (“AV”) (e.g., vehicle 100) is depicted. As shown in FIG. 2A, ML model training module 258 can include ML model training instance engine 258A, ML model training engine 258B, and ML model loss engine 258C. The ML model training module 258 can be implemented by a computing system, or by multiple computing systems in communication over one or more networks (e.g., LAN, WAN, Internet, Wi-Fi, Bluetooth, etc.) in a distributed manner. For example, one or more aspects of the ML model training module 258 can be implemented by a server that includes the ML model, and other aspects of the ML model training module 258 can be implemented by an additional server. Although particular architectures are depicted herein, it should be understood that is for the sake of example and is not meant to be limiting.

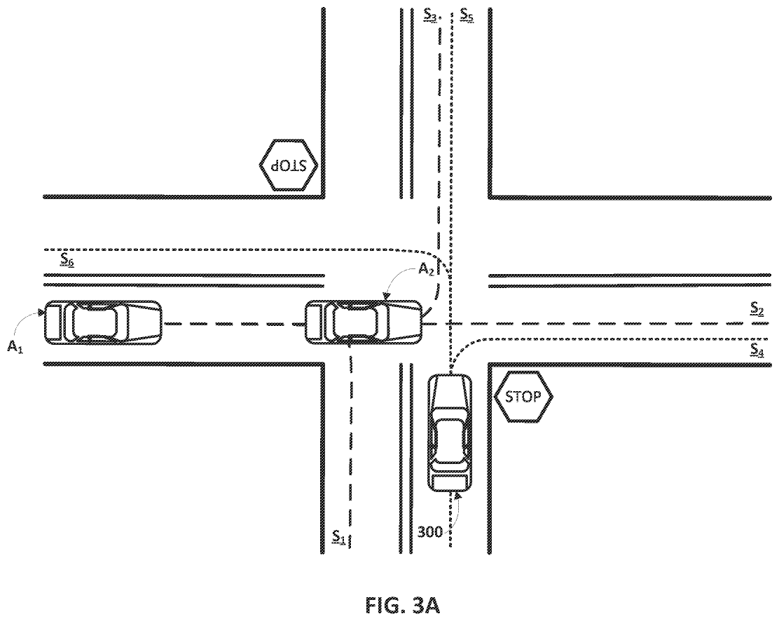

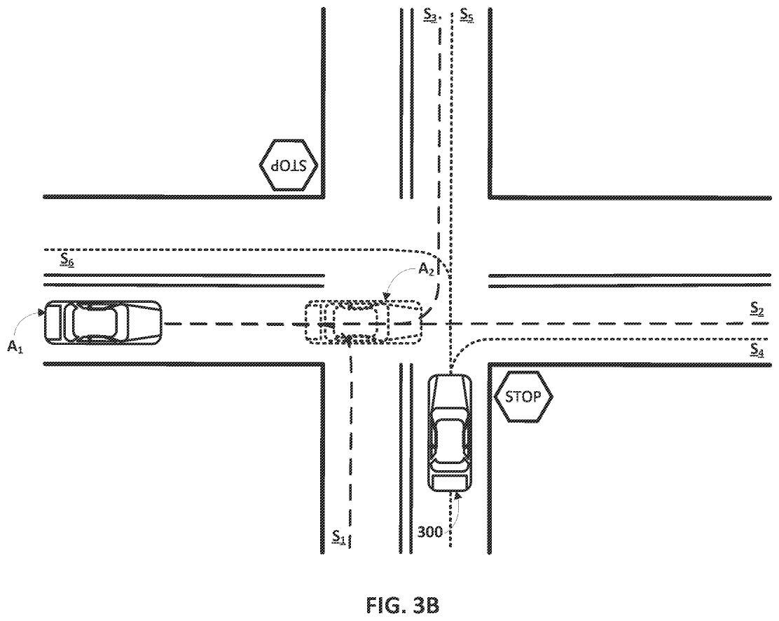

The ML model training instance engine 258A can obtain driving data from driving data database 284A (e.g., collected via the log service 182 of FIG. 1). The driving data can include one or more actors captured during a given past episode of locomotion of a vehicle, and that are specific to the given past episode. The one or more actors can each be associated with a plurality of features. The features can include, for example, velocity information associated with objects corresponding to each of the actors, distance information associated with the objects corresponding to each of the actors, and pose information associated with the objects corresponding to each of the actors. Further, the driving data can include a plurality of streams in an environment of the vehicle from the given past episode of locomotion of the vehicle. In some implementations, the driving data database 284A can include driving data for a plurality of disparate past episodes of locomotion of the vehicle (and optionally from past episodes of locomotion of other vehicles). In some implementations, the driving data can be manual driving data that is captured while a human is driving the vehicle (e.g., an AV or non-AV retrofitted with sensors (e.g., primary sensors 130 of FIG. 1)) in a real environment and in a conventional mode, where the conventional mode represents the vehicle under active physical control of a human operating the vehicle. In other implementations, the driving data can be autonomous driving data that is captured while the vehicle (e.g., an AV) is driving in a real environment and in an autonomous mode, where the autonomous mode represents the AV being autonomously controlled. In yet other implementations, the driving data can be simulated driving data captured while a virtual human is driving the vehicle (e.g. a virtual vehicle) in a simulated world. The actors, features associated with the actors, and the streams are described in greater detail below (e.g., with respect to FIGS. 3, 4A-4D, and 5A-5D).

Moreover, the ML model training instance engine 258A can generate a plurality of training instances based on the driving data stored in the driving data database 284A for training ML layers of one or more ML models in the ML model(s) database 258N1. The plurality of training instances can each include training instance input and training instance output. The ML model training instance engine 258A can generate the training instance input, for each of the plurality of training instances, by obtaining driving data for a given past episode of locomotion of the vehicle, and identifying: (i) one or more tacks from a given time instance of the given past episode; and (ii) a plurality of streams in an environment of the vehicle during the given past episode. More particularly, the ML model training instance engine 258A can identify a plurality of features associated with each of the one or more actors. The corresponding training instance output can include ground truth label(s) 284B1A (also referred to herein as reference label(s)), of the given simulated episode of locomotion of the vehicle. For example, a given ground truth label (or given reference label) can include an action taken by the vehicle (or an action that should have been taken by the vehicle), or a measure associated with each of the plurality of streams for each of the actors (e.g., a probability or other ground truth measure). The ML model training instance engine 258A can store each of the plurality of training instances in ML model training instance(s) database 284B1.

In some implementations, the ML model training instance engine 258A can generate the ground truth label(s) 284B1A (or reference label(s)) for a given training instance. The ML model training instance engine 258A can extract, for a plurality of time instances of the past episode between the given time instance and the subsequent time instance, a plurality of features associated with the objects corresponding to each of the one or more actors, determine, based on the plurality of features associated with the objects corresponding to each of the one or more actors, and for each of the plurality of time instances, a lateral distance between the objects corresponding to each of the one or more actors and each of the plurality of streams, and generate, based on the lateral distance between the objects corresponding to each of the one or more actors and each of the plurality of streams for each of the plurality of time instances, the ground truth label(s) 284B1A. In some additional or alternative implementations, the ground truth label(s) 284B1A can be defined for a given training instance based on user input detected via user input engine 290. The user input can be received subsequent to the past episode of locomotion via one or more peripheral input devices (e.g., keyboard and mouse, touchscreen, joystick, and so on). In some other versions of those implementations, the user input detected via the user input engine 290 can alter or modify the ground truth label(s) 284B1A generated by the ML model training instance engine 258A.

The ML model training engine 258B can train the ML layers of ML model(s) stored in the ML model(s) database 258N1 based on the plurality of training instances stored in the ML model training instance(s) database 284B1. The ML model training engine 258B can process, using the ML model, a given training instance input to generate predicted output(s) 258B1. The predicted output(s) 258B1 can be stored in one or more databases (not depicted) for subsequent training of additional layers of the ML model(s) as described herein (e.g., with respect to FIG. 2B). More particularly, the ML model training engine 258B can process, using the layers of the ML model(s), each of the plurality of actors and each of the plurality of streams in parallel. In some implementations, engineered geometric transformation layers stored in engineered layer(s) database 258M can process each of the actors (or features thereof) and each of the plurality of streams (or the candidate navigation paths corresponding thereto) prior to the processing by the ML model. The engineered geometric transformation layers can correspond to one or more functions that generate a tensor of values based on processing the plurality of actors and the plurality of streams. Further, in implementations that include the engineered geometric transformation layers, the tensor of values can be applied as input across the ML model to generate the predicted output(s) 258B1. The combination of the engineered geometric transformation layers and the ML model can form an instance of a geometric transformation ML model 260.

In some implementations, the predicted output(s) 258B1 can include a predicted action that the vehicle should take based on the one or more actors (or features thereof) and the plurality of streams in the environment of the vehicle. For instance, if the actors and streams of the training instance input represent an additional vehicle nudging around a parked car along a joining stream and another additional vehicle travelling behind the vehicle along the target stream, then the predicted output can include a yield action. In some additional or alternative implementations, the predicted output(s) 258B1 can include constraints on the vehicle. For instance, if the actors and streams of the training instance input represent an additional vehicle nudging around a parked car along a joining stream and another additional vehicle travelling behind the vehicle along the target stream, then the predicted output can include a vehicle constraint that indicates the vehicle cannot be located at a certain location in the environment (i.e., within a threshold distance to the parked vehicle). By using this constraint, the vehicle ensures that the additional vehicle has sufficient space to nudge around the parked car along the joining stream.

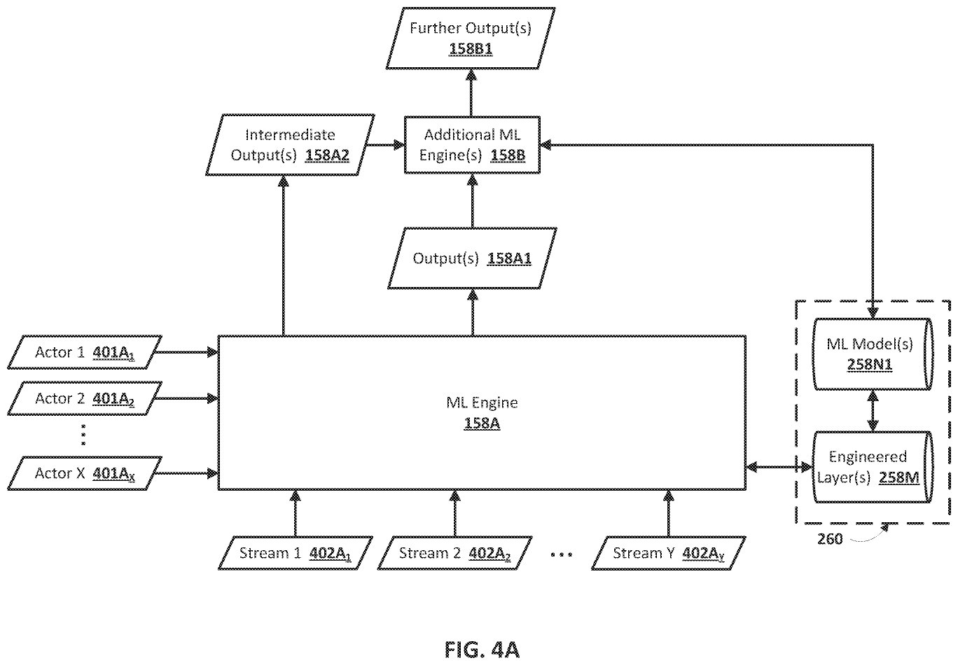

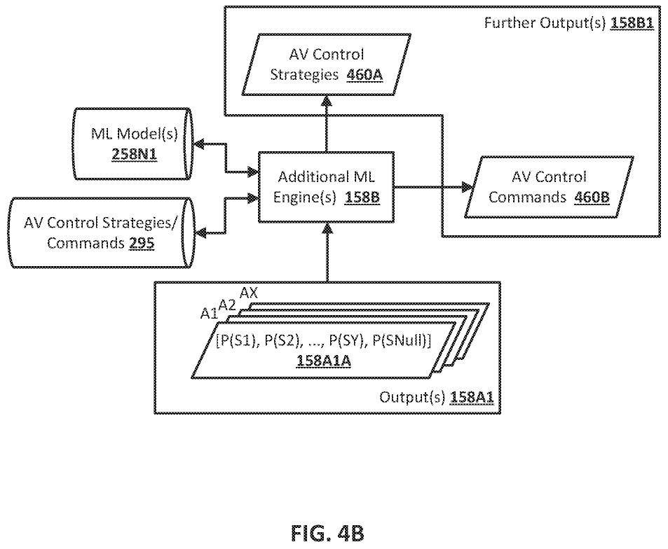

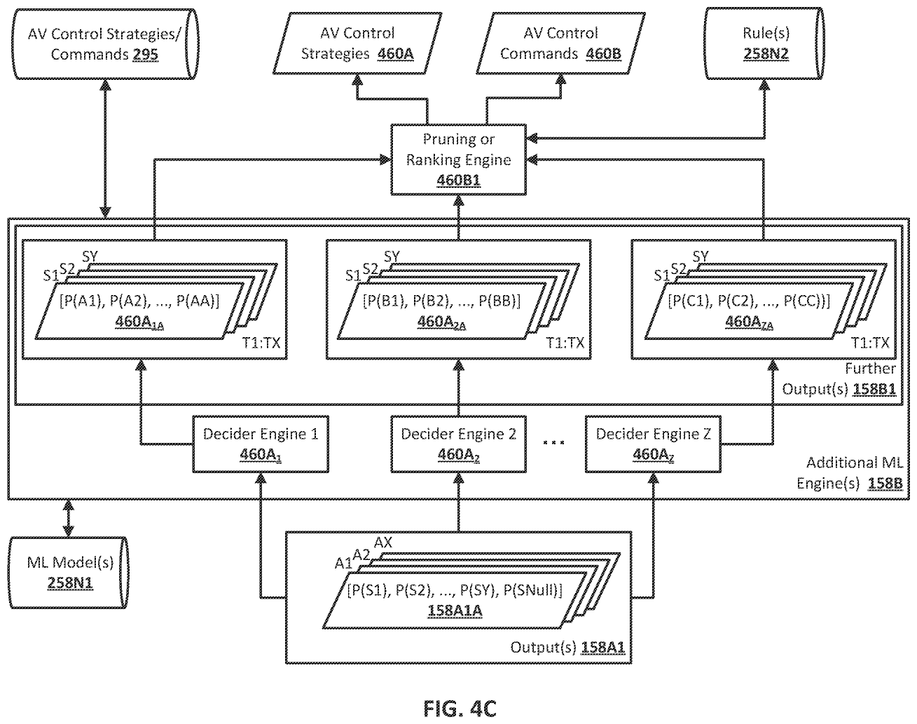

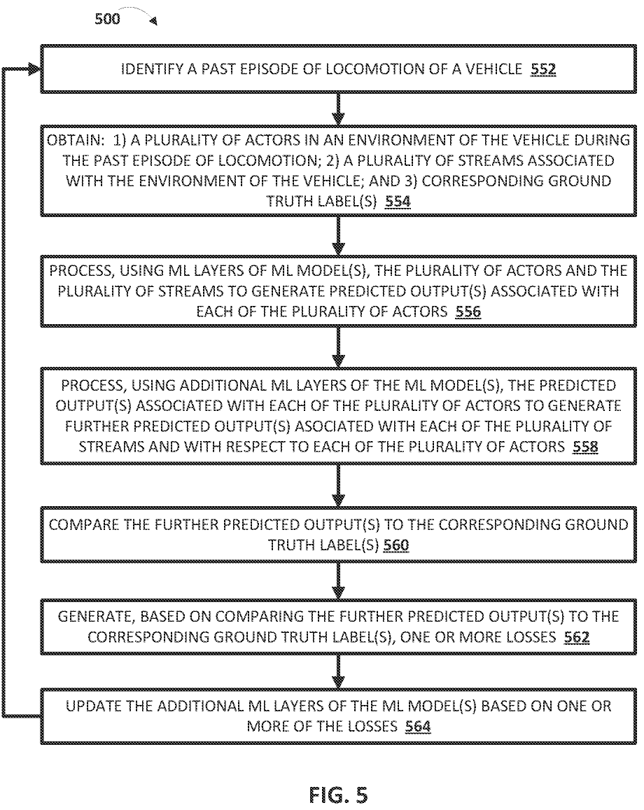

In some additional or alternative implementations, the predicted output(s) 258B1 can include predicted measures associated with each of the plurality of streams for each of the actors. The predicted measures can include, for example, one or more probability distributions for each of the actors of the training instance input. The probabilities in the probability distribution can correspond to whether a corresponding actor will follow a corresponding one of the plurality of streams of the training instance input at the subsequent time instance of the past episode of locomotion. For instance, if the actors and streams of the training instance input represent an additional vehicle nudging around a parked car along a joining stream and another additional vehicle travelling behind the vehicle along the target stream, then the predicted output can include a first probability distribution associated with the additional vehicle that is merging from the joining stream to the target stream and a second probability distribution associated with the another additional vehicle that is travelling behind the vehicle along the target stream. The first probability distribution includes at least a first probability associated with the additional vehicle being associated with the joining stream at the subsequent time instance, and a second probability associated with the additional vehicle being associated with the target stream at the subsequent time instance. Further, the second probability distribution includes at least a first probability associated with the another additional vehicle being associated with the joining stream at the subsequent time instance, and a second probability associated with the another additional vehicle being associated with the target stream at the subsequent time instance. Generating the predicted output(s) 258B1 is described in greater detail herein (e.g., with respect to FIGS. 4A, 4B, 5A, and 5B).

In some additional or alternative implementations, the predicted output(s) 258B1 can include forecasts, at one or more future time instances, and for each of the plurality of actors, based on the one or more actors (or features thereof) and the plurality of streams in the environment of the vehicle at the given time instance that are applied as input across ML model. In some versions of those implementations, the forecasts, for each of the plurality of actors, can be predicted with respect to each of the plurality of input streams in the environment of the vehicle. Further, the forecasts, for each of the plurality of actors, can be refined in successive layers of the ML model. For example, assume a forecast associated with a first object corresponding to a first actor indicates a likelihood that the object will follow a first stream at a first future time instance. The first forecast associated with the object corresponding to the first actor can be refined in successive layers of the ML to indicate that the object is more likely or less likely to follow the first stream at the first future time instance or a second future time instance. If the object is more likely to follow the first stream in this example, then the object is less likely to follow other streams in the environment of the vehicle. In contrast, if the object is less likely to follow the first stream in this example, then the object is more likely to follow other streams in the environment of the vehicle. Thus, the forecast, for each of the plurality of actors, can be defined with respect to each of the plurality of streams.

The ML layers of the ML model(s) stored in the ML model(s) database 258N1 can be, for example, a recurrent neural network (“RNN”) ML model, a transformer ML model, or other ML model(s). The ML layers of the ML model(s) can include, for example, one or more of a plurality of encoding layers, a plurality of decoding layers, a plurality of feed forward layers, a plurality of attention layers, hand-engineered geometric transformation layers, or any other additional layers. The ML layers can be arranged in different manners, resulting in various disparate portions of the ML model(s). For example, the encoding layers, the feed forward layers, and the attention layers can be arranged in a first manner to generate multiple encoder portions of the ML model(s). Further, the decoding layers, the feed forward layers, and the attention layers can be arranged in a second manner to generate multiple decoder portions of the ML model(s). The multiple encoder portions may be substantially similar in structure, but may not share the same weights. Similarly, the multiple decoder portions may also be substantially similar in structure, but may not share the same weights either. Moreover, implementations that include the hand-engineered geometric transformation layers enable the plurality of actors that are applied as input across the ML model to be projected from a first stream, of the plurality of streams, to a second stream, of the plurality of streams, and so on for each of the plurality of streams in the environment. In implementations where the ML layers of the ML model(s) and the additional layers of the ML model(s) are an end-to-end ML model, the hand-engineered geometric transformation layers enable efficient learning of embedded geometries between each of the objects corresponding to each of the plurality of actors and each of the streams of the plurality of streams. As noted above, the actors and the streams of a given training instance input can be processed in parallel using the ML layers of the ML model(s), as opposed to being processed sequentially. As a result, and in contrast with traditional ML models that include similar architectures, the predicted output(s) 25861 generated across the ML layers of the ML model(s) are not output until the processing across the ML layers of the ML model(s) is complete. In some implementations, the actors (or features thereof) and the streams of the training instance input can be represented as a tensor of values when processed using the ML model, such as a vector or matrix of real numbers corresponding to the features of the actors and the streams. The tensor of values can be processed using the ML layers of the ML model(s) to generate the predicted output(s) 258B1.

The ML model loss engine 258C can generate loss(es) 258C1 based on comparing the predicted output(s) 258B1 for a given training instance to the ground truth label(s) 284B1A for the given training instance. Further, the ML model loss engine 258C can update the ML layers of the ML model(s) stored in the ML model(s) database 258N1 based on the loss(es) 258C1. For example, the ML model loss engine 258C can backpropagate the loss(es) 258C1 across the ML layers of the ML model(s) to update one or more weights of the ML layers of the ML model(s). In some implementations, the ML model loss engine 258C can generate the loss(es) 258C1, and update the ML layers of the ML model(s) based on each of the training instances subsequent to processing each of the training instances. In other implementations, the ML model loss engine 258C may wait to generate the loss(es) 258C1 or update the ML layers of the ML model(s) subsequent to a plurality of training instances being processed (e.g., batch training). As described above, one or more aspects of the ML model training module 258 can be implemented by various computing systems. As one non-limiting example, a first computing system (e.g., a server) can access one or more databases (e.g., the driving data database 284A) to generate the training instances, generate the predicted output(s) 258B1 using the ML layers of the ML model(s), and generate the loss(es) 258C1. Further, the first computing system can transmit the loss(es) 258C1 to a second computing system (e.g., an additional server), and the second computing system can use the loss(es) 258C1 to update the ML layers of the ML model(s).

In some implementations, the ML layers of the ML model(s) trained based on the techniques described with respect to FIG. 2A can be utilized to process the plurality of actors and streams to generate predicted output associated with a plurality of subsequent time instances. For instance, the ML layers of the ML model(s) can generate first predicted output(s) associated with a first time instance (e.g., from 0.0 seconds to 3.0 seconds), second predicted output(s) associated with a second time instance (e.g., from 3.0 seconds to 5.0 seconds), and so on for a plurality of subsequent time instances. In some additional or alternative implementations, disparate portions of the ML layers of the ML model(s) trained based on the techniques described with respect to FIG. 2A can be utilized to process the plurality of actors and streams to generate predicted output associated with a plurality of subsequent time instances. For instance, a first portion of the ML layers of the ML model(s) can generate first predicted output(s) associated with a first time instance (e.g., from 0.0 seconds to 3.0 seconds), a second portion of the ML layers of the ML model(s) can generate second predicted output(s) associated with a second time instance (e.g., from 3.0 seconds to 5.0 seconds), and so on for a plurality of subsequent time instances.

Turning now to FIG. 2B, a block diagram illustrating an example training architecture for training additional ML layers of the ML model(s) of FIG. 2A is depicted. In some implementations, the training architecture for training the additional ML layers of the ML model(s) depicted in FIG. 2B is substantially similar to the training architecture for training the ML layers of the ML model(s) depicted in FIG. 2A. However, the training instances, utilized in training the additional ML layers of the ML model(s), differ from those utilized in training the ML layer(s) of the ML model(s) as described above with respect to FIG. 2B. In particular, the predicted output(s) 258B1 generated based on processing, using the layers of the ML model(s), the plurality of actors and the plurality of streams from FIG. 2A can be utilized as training instance input in training the additional layer(s) of the ML models(s), and distinct ground truth label(s) 284B2A (or distinct reference label(s)) can be utilized as training instance output.

In some implementations, the ML model training instance engine 258A can cause the predicted output(s) 25861 from FIG. 2A to be generated during training of the additional layers of the ML model(s). For instance, in training the additional ML layers of the ML model(s), the predicted output(s) 258B1 of FIG. 2A can be generated in the manner described above with respect to FIG. 2A for the purposes of training the additional ML layers of the ML model(s). The ML model training instance engine 258A can cause the predicted output(s) 258B1 from FIG. 2A to be stored in the ML model training instance(s) database 284B2. In some additional or alternative implementations, the predicted output(s) 258B1 from FIG. 2A that are generated during training of the ML layers of the ML model(s) can be stored, as training instance input, in the ML model training instance(s) database 284B2. In yet other implementations, the predicted output(s) 25861 utilized in training the additional ML layers of the ML model(s) can be defined for a given training instance based on user input detected via the user input engine 290.

In some implementations, and similar to the ground truth label(S) 284B1A of FIG. 2A, the ML model training instance engine 258A can also generate ground truth label(s) 284B1B for a given training instance. The ML model training instance engine 258A can generate, based on the past episode of locomotion of the vehicle, one or more of ground truth decisions made by the vehicle, or an operator of the vehicle, during the past episode (e.g., by a plurality of deciders as described below with respect to FIG. 4C), one or more ground truth probability distributions associated with the decisions made by the vehicle during the past episode, or one or more ground truth AV control strategies or AV control commands associated with the past episode of locomotion. In some additional or alternative implementations, the ground truth label(s) 284B2A can be defined for a given training instance based on user input detected via user input engine 290. The user input can be received subsequent to the past episode of locomotion via one or more peripheral input devices (e.g., keyboard and mouse, touchscreen, joystick, and so on). In some other versions of those implementations, the user input detected via the user input engine 290 can alter or modify the ground truth label(s) 284B2A generated by the ML model training instance engine 258A.

The ML model training engine 258B can train the additional ML layers of ML model(s) stored in the ML model(s) database 258N1 based on the plurality of training instances stored in the ML model training instance(s) database 284B2. The ML model training engine 258B can process, using the ML model, a given training instance input to generate predicted output(s) 258B2 (also referred to herein as “further predicted output(s)”). More particularly, the ML model training engine 258B can process, using the additional layers of the ML model(s), the predicted output(s) 25861 of a given training instance to generate the predicted output(s) 258B2. In some implementations, the ML layers and the additional ML layers of the ML model(s) can be trained separately. Subsequent to the separate training, the ML layers and the additional ML layers can optionally be trained together in an end-to-end manner using the architecture of FIGS. 2A and 2B. In some implementations, the ML layers can correspond to a first portion of a given ML model stored in the ML model(s) database 258N1, and the additional ML layers can correspond to one or more second portions of the given ML model stored in the ML model(s) database 258N1. In some additional or alternative implementations, the ML layers can correspond to a portion of a given ML model stored in the ML model(s) database 258N1, and the additional ML layers can correspond to one or more portions of an additional, distinct ML model stored in the ML model(s) database 258N1. In some additional or alternative implementations, the ML layers can correspond to a portion of a given ML model stored in the ML model(s) database 258N1, and the additional ML layers can correspond to portions of multiple additional, distinct ML model stored in the ML model(s) database 258N1.

In some implementations, the additional ML layers of the ML model(s) may correspond to a plurality of deciders. The additional ML layers corresponding to the plurality of deciders can correspond to distinct portions of a given ML model, or can correspond to distinct portions of multiple ML models. Each of the plurality of deciders can make a corresponding decision with respect to a vehicle or a given actor. A plurality of different deciders can be utilized to make a plurality of distinct corresponding decisions based on a plurality of actors and a plurality of stream in an environment of the AV (e.g., a merging decider, a yield decider, a pedestrian decider, a traffic light decider, and other deciders). In some implementations, each of the plurality of deciders can process the predicted output(s) 258B1, and the decisions made by each of the plurality of deciders can include the predicted output(s) generated using the additional ML layers of the ML model(s). In some further versions of those implementations, the predicted output(s) 258B2 can correspond to a corresponding predicted decision made may each of the plurality of disparate deciders. In other further versions of those implementations, the further predicted output(s) 258B2 can correspond to a corresponding predicted probability distribution associated with the corresponding decision made by each of the plurality of disparate deciders. At inference, the corresponding decision made by each of the plurality of deciders can be utilized to rank or prune AV control strategies or AV control commands (e.g., as described in greater detail below with respect to FIG. 4C).

For example, assume first additional ML layers correspond to a yield decider that is utilized to determine whether the vehicle should yield based on the predicted output(s) 258B1, second additional ML layers correspond to a traffic light decider that is utilized to determine whether the vehicle should enter an intersection based on the predicted output(s) 258B1, and third additional ML layers correspond to a pedestrian decider that is utilized to determine whether a pedestrian will enter the intersection based on the predicted output(s) 258B1. In some of these examples, the predicted output(s) 258B2 can include a predicted decision made by each of the plurality of deciders. For instance, the yield decider may indicate that the vehicle should not yield for any other vehicles in the environment of the vehicle and the traffic light decider may indicate that the vehicle should enter the intersection, but the pedestrian decider may indicate that a pedestrian has entered the intersection despite the vehicle having the traffic light decider indicating that the vehicle should enter the intersection. In these examples, the further predicted output(s) 258B2 can correspond to the predicted decisions made by each of the deciders. Moreover, the ML loss engine 258C can compare each of the predicted decisions included in the further predicted output(s) 258B2 to ground truth decisions made by the vehicle to generate the loss(es) 258C2. The loss(es) 258C2 can be utilized to update a corresponding portion of the additional ML layers of the ML model(s) that correspond to a given decider that made the corresponding decision. Continuing with the above example, assume that the pedestrian did not enter the intersection. In this example, the predicted decision of the pedestrian entering the intersection (e.g., 1.0) can be compared to the actual decision of the pedestrian not entering the intersection (e.g., 0.0) to generate the loss(es) 258C2, and the loss(es) 258C2 can be backpropagated across the portion of the additional ML layers corresponding to the pedestrian decider to update weights associated with that portion of the additional ML layers.

In other examples, the predicted output(s) 258B2 can include a corresponding predicted probability distribution associated with the predicted decision made by each of the plurality of disparate deciders. For instance, the yield decider may indicate that the vehicle should not yield for any other vehicles in the environment of the vehicle with a probability of 0.6 (e.g., and should yield with a probability of 0.4) and the traffic light decider may indicate that the vehicle should enter the intersection with a probability of 0.7 (e.g., and should not enter the intersection with a probability of 0.3), but the pedestrian decider may indicate that a pedestrian has entered the intersection with a probability of 0.55 (e.g., and that the pedestrian has not entered the intersection with a probability of 0.45) despite the vehicle having the traffic light decider indicating that the vehicle should enter the intersection. In these examples, the further predicted output(s) 258B2 can correspond to the predicted probability distributions made by each of the deciders. Moreover, the ML loss engine 258C can compare each of the predicted probability distributions included in the further predicted output(s) 258B2 to ground truth decisions made by the vehicle to generate the loss(es) 258C2. The loss(es) 258C2 can be utilized to update a corresponding portion of the additional ML layers of the ML model(s) that correspond to a given decider that made the corresponding decision. Continuing with the above example, assume that the pedestrian did not enter the intersection. In this example, the predicted probability of the pedestrian entering the intersection (e.g., 0.55) can be compared to the actual probability of the pedestrian entering the intersection (e.g., 0.0) to generate the loss(es) 258C2, and the loss(es) 258C2 can be backpropagated across the portion of the additional ML layers corresponding to the pedestrian decider to update weights associated with that portion of the additional ML layers.

In these implementations, the predicted output(s) 258B2 generated based on the processing by each of the plurality of deciders can be utilized to prune or rank AV control strategies or AV control strategies from a list of AV control strategies or AV control commands. The list of AV control strategies can be stored in one or more databases (e.g., AV control strategies/commands database 295), and can include, for example, a yield strategy, a merge strategy, a turning strategy, a traffic light strategy, an accelerating strategy, a decelerating strategy, or a constant velocity strategy. Additionally or alternatively, the list of AV control commands can also be stored in one or more databases (e.g., AV control strategies/commands database 295), and can include, for example, a magnitude corresponding to one or more of a velocity component, an acceleration component, a deceleration component, or a steering component. For example, if output from a traffic light decider indicates that the AV should proceed into the intersection, but output from a pedestrian decider indicates the AV should yield to a pedestrian that has entered the intersection, then an accelerating strategy can be pruned from the list of AV control strategies, or any AV control commands that have a magnitude corresponding to an acceleration component can be pruned from the list of AV control commands. As another example, if output from a traffic light decider indicates that the AV should proceed into the intersection, but output from a pedestrian decider indicates the AV should yield to a pedestrian that has entered the intersection, then an accelerating strategy can be demoted in a ranked list of AV control strategies, or any AV control commands that have a magnitude corresponding to an acceleration component can be demoted in the ranked list of AV control commands, and AV control strategies or AV control commands associated with decelerating or yielding to the pedestrian can be promoted. A remaining AV control strategy or remaining AV control commands, or a highest ranked AV control strategy or highest rank AV control commands, can be selected for utilization in controlling the AV. In these implementations, the selected AV control strategy of AV control commands can be compared to the ground truth label(s) 284B2A to generate the loss(es) 258C2, and the loss(es) 258C2 can be utilized to update the additional ML layers corresponding to the plurality of deciders. For example, the ground truth label(s) 284B2A can correspond to a ground truth AV control strategy or ground truth AV control commands from the past episode of locomotion, or defined for the vehicle subsequent to the past episode of locomotion, to generate the loss(es) 258C2 for each of the plurality of deciders, and the loss(es) 258C2 can be backpropagated across the additional ML layers that correspond to the plurality of deciders.

In some additional or alternative implementations, the additional ML layers of one or more of the ML models can be a proxy for the plurality of disparate deciders, and the predicted output(s) 258B2 can correspond to an AV control strategy or AV control commands. In other words, the plurality of disparate deciders may be omitted, and the predicted output(s) 258B2 generated by processing the predicted output(s) 258B1 can directly indicate the AV control strategy or AV control commands. Further, the AV control strategy or AV control commands generated based on the predicted output(s) 25861 can include a pruned list or ranked list of the AV control strategies or AV control commands. Moreover, a remaining AV control strategy or AV control commands, or highest ranked AV control strategy or AV control commands can be selected for utilization in controlling the AV. In these implementations, the selected AV control strategy of AV control commands can be compared to the ground truth label(s) 284B2A to generate the loss(es) 258C2, and the loss(es) 258C2 can be utilized to update the additional ML layers in a similar manner described above. At inference, the additional ML layers of the ML model(s) can directly output the remaining AV control strategy or AV control commands, or the highest ranked AV control strategy or AV control commands (e.g., as described in greater detail below with respect to FIG. 4B).

Turning now to FIGS. 3A and 3B, an example environment from a past episode of locomotion of a vehicle 300 that is utilized in training the ML layers of the ML model(s) of FIG. 2A, and the additional ML layers of the ML model(s) of FIG. 2B is depicted. The environment of FIG. 3 is described herein with respect to using a past episode of locomotion of vehicle 300 to train the layers and the additional ML layers of the ML model(s) (e.g., using ML model training module 258 of FIGS. 2A and 2B). In particular, the environment depicted in FIGS. 3A and 3B can be captured by a sensor data instance of sensor data generated by one or more sensors of the vehicle 300 at the given time instance of the past episode of locomotion of the vehicle 300. As shown in FIGS. 3A and 3B, the environment includes the vehicle 300 at a stop sign of a 4-way intersection where cross traffic does not stop. The vehicle 300 may be an AV (e.g., vehicle 100 of FIG. 1) or a non-AV retrofitted with sensors (e.g., primary sensors 130 of FIG. 1) in a real environment, or a simulated vehicle in a simulated environment. Further, the environment shown in FIGS. 3A and 3B also includes two additional vehicles as objects corresponding a first actor A₁ and a second actor A₂, respectively. The first actor A₁ and the second actor A₂ can each be associated with a plurality of features (e.g., velocity information, distance information, and pose information).

In some implementations, the plurality of features can be defined with respect to the actors A₁ and A₂. For example, the plurality of features associated with the first actor A₁ can include a lateral distance between the first actor A₁ and each of the plurality of streams (e.g., a lateral distance between T₁ and S₁), a lateral distance between the first actor A₁ and the second actor A₂, a lateral distance between the first actor A₁ and one or more lane lines, a longitudinal distance between the first actor A₁ and the second actor A₂, an absolute velocity of the first actor A₁, a relative velocity of the first actor A₁ with respect to the second actor A₂, an acceleration of the first actor A₁, and so on. Further, the plurality of features associated with the second actor A₂ can include similar features, but with respect to the second actor A₂. In some additional or alternative implementations, the plurality of features can be defined with respect to the vehicle 300. For example, the plurality of features associated with the first actor A₁ can include a lateral distance between the first actor A₁ and the vehicle 300, a longitudinal distance between the first actor A₁ and the vehicle 300, and a relative velocity of the first actor A₁ with respect to the vehicle 300. In some implementations, the plurality of features provides geometric information between the actors A₁ and A₂ and the vehicle 300. The ML layers of the ML model(s) can be used to leverage this geometric information to forecast candidate navigation paths of the actors A₁ and A₂ at subsequent time instances based on the plurality of features at a given time instance. In various implementations, utilizing this geometric information as part of the input features that are processed using the ML layers of the ML model(s) can enable more efficient training of the ML layers of the ML model(s) or can result in increased robustness and accuracy of the ML layers of the ML model(s) during use.

Moreover, the environment shown in FIGS. 3A and 3B also includes a plurality of streams S₁-S₆ of a plurality of disparate types of streams. Each of the streams correspond to a sequence of poses representing a candidate navigation path, in the environment of the vehicle 300, for the vehicle 300 or the objects corresponding to the first actor A₁ and the second actor A₂. With respect to the environment depicted in FIGS. 3A and 3B, assume that the vehicle 300 will navigate straight through the four-way intersection and along stream S₅. In this example, stream S₅ may be considered a target stream since it is a stream that the vehicle 300 is immediately preparing to follow by navigating straight through the four-way intersection. In this example, stream S₃ may be considered a joining stream since it merges into target stream S₅. Although stream S₃ is depicted as a distinct stream that does not merge with target stream S₅, it should be understood that is for the sake of clarity. Further, stream S₂ may be considered a crossing stream since it transverses target stream S₅. Stream S₁ may be considered an adjacent stream since it is adjacent, or parallel, to target stream S₅. In some examples, stream S₂ may also be considered a crossing stream, in addition to being considered an adjacent stream, since stream S₂ is also transverse to target stream S₇ in the middle of the intersection. Lastly, streams S₄ and S₆ may be considered additional streams. As another example, assume that the vehicle 300 will turn left at the four-way intersection depicted in FIG. 3 along stream S₆. In this example, stream S₆ may be considered a target stream since it is a stream that the vehicle is immediately preparing to follow by turning left at the four-way intersection. In this example, streams S₂ and S₃ may be considered crossing streams since they traverse target stream S₉. Stream S₁ and may be considered an adjacent stream since it is adjacent, or parallel, to target stream S₉. Lastly, streams S₄ and S₅ may be considered additional streams.

In these examples, the additional vehicles corresponding to the first actor A₁ and the second actor A₂ have right-of-way over the vehicle 300 in navigating through the intersection depicted in FIGS. 3A and 3B. In particular, the vehicle 300 is at a stop sign, whereas neither of the additional vehicles corresponding to the first actor A₁ and the second actor A₂ have a stop sign as they enter the intersection. As such, this reported right-of-way indicates that the vehicle 300 should yield at the stop sign until the additional vehicles corresponding to the first actor A₁ and the second actor A₂ clear the four-way intersection depicted in FIGS. 3A and 3B. Although the environments of FIGS. 3A and 3B are depicted as having particular streams, it should be understood that this is for the sake of example and is not meant to be limiting. For instance, additional streams may be included if the vehicle 300 or the objects corresponding to the actors are allowed to take a U-turn at the intersection, or if a pedestrian crosswalk is included in the environment of the vehicle 300.

The first actor A₁ and the second actor A₂ (or respective features thereof), and of the plurality of streams S₁-S₆ depicted in FIG. 3A can be processed, using the ML layers of the ML model(s), to generate predicted output(s). In some implementations, the actors and streams are processed, using the ML layers of the ML model(s), in a parallelized manner. In other words, there is no particular sequence or order that the actors and streams need to be processed using the ML layers of the ML model(s). The predicted output(s) generated based on processing the plurality of actors and plurality of streams is described in greater herein (e.g., with respect to FIG. 2A). In some implementations, the predicted output(s) can be one or more predicted actions that the vehicle 300 should perform based on the actors and streams processed using the ML layers of the ML model(s). For instance, the one or more predicted actions can include an indication that the vehicle 300 should yield at a particular location in the environment (e.g., at the stop sign), that the vehicle 300 should enter the intersection and turn in a desired direction or navigate through the intersection, and so on. In some additional or alternative implementations, the predicted output(s) can include one or more constraints for the vehicle 300 based on the actors and streams processed using the ML layers of the ML model(s). In contrast with the one or more predicted actions that should be performed by the vehicle 300, the one or more constraints for the vehicle 300 indicate actions that the vehicle 300 cannot take or locations in the environment that the vehicle cannot be located. For instance, the one or more constraints can include an indication that the vehicle 300 cannot accelerate along the target stream to allow an additional vehicle corresponding to a given actor to merge from a joining stream to a target stream that the vehicle 300 is navigating, that indicates the vehicle 300 cannot enter a given intersection, and so on. In some additional or alternative implementations, the predicted output(s) can include one or more predicted measures associated with each of the actors. The predicted measures can be, for example, probability distributions associated with each of the plurality of actors. The predicted output(s) can be compared to corresponding ground truth label(s) generated based on the past episode of locomotion, or defined for the past episode of locomotion, to generate one or more losses. The predicted output(s) generated based on processing the plurality of actors and plurality of streams, and generating one or more of the losses to update the ML layers of the ML model is described in greater herein (e.g., with respect to FIG. 2A).

Further, the predicted output(s) generated based processing the first actor A₁ and the second actor A₂ (or respective features thereof), and of the plurality of streams S₁-S₆ can be processed, using the additional ML layers of the ML model(s), to generate further predicted output(s). In some implementations, the further predicted output(s) can include a corresponding predicted decision made by each of a plurality of disparate deciders or a corresponding predicted probability distribution for each of the streams and with respect to each of the actors (e.g., as described with respect to FIG. 4C). In some versions of those implementations, the corresponding decisions, or the corresponding probability distributions, for each of the plurality of disparate deciders, can be utilized to predict a control strategy or control commands that the vehicle 300 should implement at a current time or future time(s). In some additional or alternative implementations, the further predicted output(s) can include the predicted control strategy or control commands that the vehicle 300 should implement at a current time or future time(s) without determining the intermediate decisions by the plurality of deciders. The further predicted output(s) can be compared to corresponding ground truth label(s) to generate loss(es) for updating the additional ML layers of the ML model(s).

In various implementations, one or more of the actors can be omitted in training the additional ML layers of the ML model(s) by modifying the past episode of locomotion. By omitting one or more of the actors, the additional ML layers of the ML model(s) can be attentioned to objects that may also influence actions to be performed by the AV. For example, as shown in FIG. 3B, the second actor A₂ (and features thereof) can be omitted from training instances. In this manner, the additional ML layers of the ML model(s) can be trained to make decisions on each object corresponding to the actors in the environment of the vehicle 300. For example, in the environment of FIG. 3A, a control strategy for the vehicle 300 may be to yield at the stop sign based on the second actor A₂ passing through the intersection. However, the additional ML layers of the ML model(s) may assign too much weight to the fact that the vehicle 300 should yield at the stop sign due to the second actor A₂ being present in the intersection. However, by also updating the additional ML layers of the ML model(s) based on the environment of FIG. 3B, the ML model(s) may also learn that vehicle 300 should yield at the stop sign not only because of the second actor A₂ is passing through the intersection, but also because the first actor A₁ is approaching the intersection and has the right-of-way at the intersection.

Turning now to FIGS. 4A-4C, block diagrams illustrating example architectures for using the trained ML layers of the ML model(s) of FIG. 2A and the trained additional ML layers of the ML model(s) of FIG. 2B in controlling an autonomous vehicle are depicted. The ML engine 158A (e.g., referenced above with respect to FIG. 2A) can process, using the ML layers of the ML model(s) stored in ML model(s) database 258N1, a plurality of actors and a plurality of streams to generate output(s) 158A1. For instance, an environment of the AV can be identified based on sensor data generated by one or more sensors of the AV, and a corresponding object corresponding to each of the plurality of actors can be captured in the sensor data. The plurality of streams can be identified (e.g., from a prior mapping of the environment accessed via mapping subsystem 162 of FIG. 1) based on the environment or the plurality of actors captured in the environment. In some implementations, the plurality of actors (or features thereof) and the plurality of streams can be represented as a tensor of values, such as a vector or matrix of real numbers corresponding to the features of the plurality of actors and the plurality of streams. Further, the additional ML engine(s) 158B (e.g., referenced above with respect to FIG. 2B) can process, using the additional ML layers of the ML model(s) stored in ML model(s) database 258N1, the output(s) 158A1 (and optionally intermediate output(s) 158A2 generated by the ML engine 158A) to generate further output(s) 158B1.

In some implementations, the ML model may be a portion of an instance of a geometric transformation ML model 260. The instance of the geometric transformation ML model 260 may also include engineered geometric transformation layers stored in engineered layer(s) database 258M. If included, the engineered geometric transformation layers can process each of the actors (or features thereof) and each of the plurality of streams (or the candidate navigation paths corresponding thereto) prior to the processing by the ML model. The engineered geometric transformation layers can correspond to one or more functions that generate a tensor of values based on processing the plurality of actors and the plurality of streams. Further, the tensor of values can be applied as input across the ML model to generate the predicted output(s) 258B1.

For example, as shown in FIG. 4A, the plurality of actors can include Actor 1 401A₂, Actor 2 401A₂, and so on through Actor X 401A_{X}, where X is a positive integer corresponding to a quantity of actors in the environment of the AV. Further, the plurality of streams can include Stream 1 402A₁, Stream 2 402A₂, and so on through Stream Y 402A_{Y}, where Y is a positive integer corresponding to a quantity of candidate navigation paths in the environment of the AV. In some implementations, the plurality of actors (or features thereof) and the plurality of streams can be processed, using the ML layers of the ML model(s), in a parallelized manner as shown in FIG. 4A (and optionally as tensor of values generated using the engineered geometric transformation layers described with respect to 258M). In processing the plurality of actors and the plurality of streams in a parallelized manner, the ML layers of the ML model(s) seek to project features of each of the actors onto each of the plurality of streams in the environment of the AV. In other words, the AV can continually process the actors and streams in the environment of the AV to determine relationships between each of the actors and each of the streams, and in a manner that allows the AV to predict current and future positions and orientations of actors in the environment of the AV. The ML engine 158A may withhold the output(s) 158A1 (and optionally the intermediate output(s) 158A2) until the processing of the plurality of actors and the plurality of streams across the ML layers of the ML model(s) is complete. Further, the additional ML engine(s) 158B can process, using the additional ML layers of the ML model(s) stored in the ML model(s) database 258N1, the output(s) 158A1 to generate further output(s) 158B1.

In some implementations, the output(s) 158A1 can include a probability distribution associated with each of the actors. For example, as shown in FIG. 4B, the output(s) 158A1 can include a first probability distribution 158A1A associated with Actor 1 401A₁, a second probability distribution associated with Actor 2 401A₂, and so on through Actor X 401A_{X}. The probability distributions associated with each of the actors can include a respective probability that a corresponding object corresponding to each of the actors will follow a given one of the streams associated with the respective probability at a future time instance of the current episode of locomotion of the AV. For instance, the first probability distribution 158A1A includes a first probability P(S1) that indicates a probability the object corresponding to Actor 1 401A₁ will follow Stream 1402A₁ at the future time instance, a second probability P(S2) that indicates a probability the object corresponding to Actor 1 401A₁ will follow Stream 2 402A₂ at the future time instance, and so on through Stream Y 402A_{Y}. Further, the first probability distribution 158A1A can also include a null probability P(SNull) that indicates a probability the object corresponding to Actor 1401A₁ is associated with a null stream at the future time instance.

In some versions of those implementations, the additional ML engine(s) 158B can process, using the additional ML layers of the ML model(s), each of the probability distributions of the output(s) 158A1 to generate the further output(s) 158B1. As shown in FIG. 4B, the further output(s) 158B1 can include AV control strategies 460A or AV control commands 460B. The AV can be controlled based on the selected AV control strategies 460A or the AV control commands 460B. The AV control strategies 460A or AV control commands 460B can be selected from among a plurality of disparate AV control strategies or AV control commands that are stored in the AV control strategies/commands database 295. In some further versions of those implementations, the further output(s) 158B1 generated by the additional ML engine(s) 158B can include ranked AV control strategies 460A or ranked AV control commands 450B. In these implementations, the AV can be controlled based on a highest ranked one of the AV control strategies 460A or highest ranked AV control commands 460B. In some implementations, these implementations of the additional ML engine(s) 158B omit a plurality of disparate deciders. In other words, the additional ML layers of the ML model(s) can serve as a proxy for each of the plurality of disparate deciders.

In some additional or alternative implementations, the additional ML layers of the ML model(s) can correspond to a plurality of disparate deciders, and the additional ML engine(s) 158B can process, using each of the plurality of disparate deciders, each of the probability distributions of the output(s) 158A1 to generate the further output(s) 158B1. For example, as shown in FIG. 4C, the additional ML engine(s) 158B can include decider engine 1 460A₁, decider engine 2 460A₂, and so on through decider engine Z 460A_{Z}, where Z is a positive integer corresponding to a quantity of deciders trained for use by the additional ML engine(s) 158B. Each of the plurality of different deciders can correspond to a respective portion of the additional ML layers of the ML model(s) stored in the ML model(s) database 258N1, and can be utilized to make a plurality of distinct corresponding decisions based on processing of the output(s) 158A1. For example, a yield decider can correspond to a first portion of the additional ML and can be utilized to determine whether the AV should yield, a merge decider can correspond to a second portion of the additional ML layers and can be utilized to determine whether the AV should yield, a joining stream decider can correspond to a third portion of the additional ML layers and can be utilized to determine whether a given actor is merging into a target stream of the AV, a crossing stream decider can correspond to a fourth portion of the be utilized to determine whether a given actor is crossing the target stream of the AV, and so on for a plurality of additional or alternative decisions. In some implementations, the respective portions of the additional implementations are portions of multiple distinct ML models, whereas in other implementations, the respective portions are distinct portions of the same ML model.

Moreover, each of the plurality of disparate deciders can process the output(s) 158A1 to generate the further output(s) 158B1. In some versions of those implementations, the further output(s) 158B1 can include a further corresponding probability distribution for each of the streams (e.g., as indicated in FIG. 4C with a corresponding probability distribution associated with S1-SY), and with respect to each of the actors (e.g., as indicated in FIG. 4C by T1:TX). For instance, assuming that the output(s) 158A1 include the corresponding probability distributions associated with each of the actors, each of the plurality of disparate deciders can process each of the corresponding probability distributions associated with each of the actors to generate, for each of the actors, a further corresponding probability distribution associated with each of the streams. The further corresponding probability distributions can each include a respective probability associated with each decision. For example, first further output 460A_{1A}, of the further output(s) 158B1, generated by decider engine 1 460A₁ can include a first probability P(A1) associated with a corresponding decision made by the decider engine 1 460A₁, a second probability P(A2) associated with another corresponding decision made by the first decider 460A₁, and so on through P(AA) associated with other corresponding decisions made by the first decider 460A₁ In some implementations, the first further output 460A_{1A} generated by decider engine 1460A₁ can include these probability distributions for each of the streams, and with respect to each of the actors. In this example, assume the decider engine 460A₁ utilizes additional ML layers that correspond to a yield decider that determines whether the AV should yield for a given object corresponding to a given actor based on the stream that the given object corresponding to the given actor is following or is predicted to follow in the future. The first probability P(A1) for the first stream S1, of the first further output 460A_{1A} of the further output(s) 158B1, can correspond to a probability that the AV should yield for the given object when navigating along the first stream at a current or future time, and the second probability P(A₂) for the first stream, of the first further output 460A_{1A} of the further output(s) 158B1, can correspond to a probability that the AV should not yield for the given object when navigating along the first stream at a current or future time. Similar probability distributions for each of the streams, and with respect to each of the actors, can be generated as the first further output 460A_{1A} of the first decider 460A₁. Moreover, each decider can generate probability distributions in a similar manner as the further output(s) 158B1. For example, decider engine 2 can generate second further output 460A_{1A} of the further output(s) 158B1, decider engine Z 460A_{Z} can generate additional further output 460A_{ZA} of the further output(s) 158B1, and so on for each of the remaining decider engines.

In some further versions of those implementations, pruning or ranking engine 460B1 can process the further output(s) 158B generated by the plurality of disparate deciders to rank the AV control strategies 460A or the AV control commands 460B stored in the AV control strategies/commands database 295. The pruning or ranking engine 460B1 can utilize one or more rules stored in rule(s) database 258N2 to prune or rank the AV control strategies 460A or the AV control commands 460B. The rule(s) stored in the rule(s) database 258N2 can include, for example, one or more ML rules generated by the ML model(s), one or more heuristically defined rules that are defined by one or more humans, or any combination thereof. For example, assume the pruning or ranking engine 460B1 retrieves a list of AV control strategies or AV control commands (e.g., from the AV control strategies/commands database 295). In some of these examples, the pruning or ranking engine 460B1 can process the further output(s) 158B, using the rule(s) (e.g., stored in the rule(s) database 258N2), to prune one or more AV control strategies or AV control commands from the list of AV control strategies or AV control commands until a given one of the AV control strategies or AV control commands remain on the list. The remaining AV control strategy or the remaining AV control commands can be utilized in controlling the AV. In other examples, the pruning or ranking engine 460B1 can process the further output(s) 158B1, using the rule(s) (e.g., stored in the rule(s) database 258N2), to rank one or more AV control strategies or AV control commands from the list of AV control strategies or AV control commands, and a highest ranked one of the AV control strategies or AV control commands on the list can be utilized in controlling the AV.

In various implementations, these AV control strategies or AV control commands can be implemented by, for example, control subsystem 160 of vehicle 100 of FIG. 1. For example, the list of AV control strategies can include, for example, a yield strategy, a merge strategy, a turning strategy, a traffic light strategy, an accelerating strategy, a decelerating strategy, or a constant velocity strategy. In these examples, the AV can implement control commands associated with each of these control strategies. Additionally or alternatively, the AV control commands can include, for example, a magnitude corresponding to one or more of a velocity component, an acceleration component, a deceleration component, or a steering component. In these examples, the AV can directly implement the control commands.

Turning now to FIG. 5, a flowchart illustrating an example method 500 of training additional layers of one or more ML models is depicted. For convenience, the operations of the method 500 are described with reference to a system that performs the operations. The system may include various components of various devices, including those described in FIGS. 2A and 2B, server(s), local computing device(s) (e.g., laptop, desktop computer, and so on), other computing systems having memory and processors, or any combination thereof. Moreover, while operations of the method 500 are shown in a particular order, this is not meant to be limiting. One or more operations, elements, or steps may be reordered, omitted, or added.

At block 552, the system identifies a past episode of locomotion. The past episode of locomotion of the vehicle can be captured in driving data generated by the vehicle. In particular, the driving data can include sensor data generated by sensors of the vehicle during the past episode of locomotion. In some implementations, the driving data can be manual driving data that is captured while a human is driving a vehicle (e.g., an AV or non-AV retrofitted with sensors (e.g., primary sensors 130 of FIG. 1)) in a real environment and in a conventional mode, where the conventional mode represents the vehicle under active physical control of a human operating the vehicle. In other implementations, the driving data can be autonomous driving data that is captured while an AV is driving in a real environment and in an autonomous mode, where the autonomous mode represents the AV being autonomously controlled. In yet other implementations, the driving data can be simulated driving data captured while a virtual human is driving a virtual vehicle in a simulated world.

At block 554, the system obtains: 1) a plurality of actors in an environment of the vehicle during the past episode of locomotion; 2) a plurality of streams associated with the environment of the vehicle; and 3) corresponding ground truth label(s). The plurality of actors may each correspond to an object in the environment of the vehicle. The objects can include, for example, additional vehicles that are static in the environment (e.g., a parked vehicle) or dynamic in the environment (e.g., a vehicle merging into a lane of the AV), bicyclists, pedestrians, or any other dynamic objects in the environment of the vehicle. Further, each of the plurality of actors can be associated with a plurality of features. The features can include, for example, velocity information associated with each of the actors, distance information associated with each of the actors, and pose information associated with each of the actors. The velocity information can include historical, current, and predicted future velocities of the object corresponding to each of the plurality of actors. The distance information can include a lateral distance from the object corresponding to each of the plurality of actors to each of the plurality of streams. The pose information can include position information and orientation information, of the object corresponding to each of the plurality of actors, within the environment of the vehicle.

Further, the plurality of streams may each correspond to a sequence of poses that represent candidate navigation paths, in the environment of the vehicle, for the vehicle or the actors. The plurality of streams can be stored in a previously generated mapping of the environment of the vehicle. Each of the plurality of streams can belong to one of multiple disparate types of streams. The multiple disparate types of streams can include, for example, a target stream that the vehicle followed, joining streams that merge with the target stream, crossing streams that transverse the target stream, adjacent streams that are parallel to the target stream, additional streams that are one-hop from any of the other streams, or a null stream. The type of stream, for a given one of the plurality of streams, may be based on a relationship of the plurality of streams to the target stream (e.g., as described above with respect to FIGS. 3A and 3B).

In some implementations, the corresponding ground truth label(s) can be obtained based on user input that defines the corresponding ground truth label(s) to the past episode of locomotion. In some additional or alternative implementations, the corresponding ground truth label(s) can be generated based on the past episode of locomotion. For example, the system can extract, from the past episode of locomotion, features associated with each of the plurality of actors for a corresponding plurality of time instances between a given time instance and a subsequent time instance of the corresponding plurality of time instances. Based on the extracted features, the system can determine one or more of control strategies utilized the vehicle at each of the corresponding plurality of time instances, control commands utilized the vehicle at each of the corresponding plurality of time instances, decisions made by various components (e.g., deciders), actions performed by objects in the environment of the vehicle, or other actions or decisions that influence control of the vehicle during the past episode of locomotion of the vehicle.

At block 556, the system processes, using ML layers of ML model(s), the plurality of actors and the plurality of streams to generate predicted output(s) associated with each of the plurality of actors. In some implementations, the system can process the plurality of actors (or features thereof) and the plurality of streams using the ML model in a parallelized manner. Further, the predicted output(s) may not be output until the ML model has completed processing of the plurality of actors and the plurality of streams. The predicted output(s) can include at least one of: (i) a probability distribution for each of the plurality of actors, where each probability in the probability distribution is associated with a given one of the plurality of streams at the given time instance or the subsequent time instance; (ii) one or more actions that the vehicle should perform at the given time instance or the subsequent time instance; or (iii) one or more constraints on the vehicle at the given time instance or the subsequent time instance. The predicted output(s) are described in greater detail herein (e.g., with respect to FIG. 2A).

At block 558, the system processes, using additional ML layers of the ML model(s), the predicted output(s) associated with each of the plurality actors to generate further predicted output(s) associated with each of the plurality of streams and with respect to each of the plurality of actors. In some implementations, the additional ML layers of the ML model(s) can correspond to one or more portions of the same ML model that includes the ML layers described above with respect to block 556, while in the other implementations, the additional ML layers of the ML model(s) correspond to one or more portions of additional ML model(s) that are distinct from the ML model that includes the ML layers described above with respect to block 556. In some implementations, the additional ML layers can include portions that correspond to a plurality of disparate deciders, whereas in other implementations the plurality of disparate deciders are omitted.

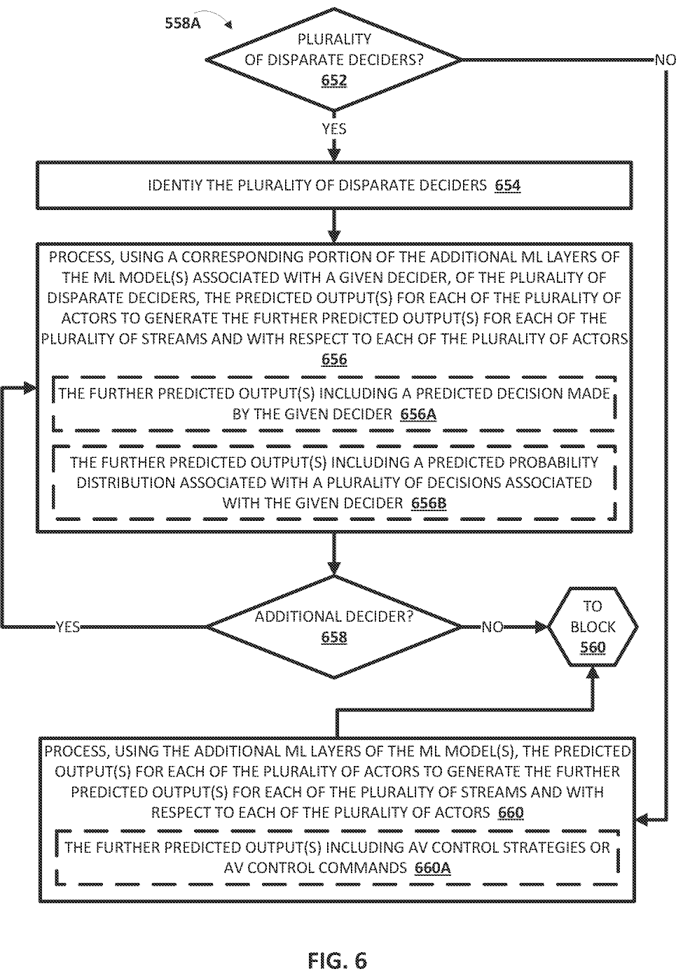

For example, referring to FIG. 6, a flowchart illustrating an example method 558A of generating the further predicted output(s) utilized in training the additional ML layers of the ML model(s) at block 558 for the method 500 of FIG. 5. At block 652, the system determines whether the additional ML layers of the ML model(s) correspond to a plurality of disparate deciders. If, at an iteration of block 652, the system determines that the additional ML layers correspond to a plurality of disparate deciders, the system proceeds to block 656. At block 654, the system identifies the plurality of disparate deciders. The plurality of disparate deciders can be utilized to make a plurality of distinct corresponding decisions based on the predicted output(s) generated at block 556 of FIG. 5. The deciders are described in more detail herein (e.g., with respect to FIGS. 2B and 4C). At block 656, the system processes, using a corresponding portion of the additional ML layers of the ML model(s) associated with a given decider, of the plurality of disparate deciders, the predicted output(s) for each of the plurality of actors to generate the further predicted output(s) for each of the plurality of actors to generate the further predicted output(s) for each of the plurality of stream and with respect to each of the plurality of actors. In some of these implementations, the further predicted output(s) can optionally include a predicted decision made by the given decider as indicated by optional sub-block 656A. In some additional or alternative implementations, the further predicted output(s) can optionally include a predicted probability distribution associated with a plurality of decisions associated with the given decider as indicated by optional sub-block 656B.

At block 658, the system can determine whether the plurality of deciders include an additional decider that is in addition to and distinct from the given decider discussed above in connection with block 656. If, at an iteration of block 658, the system determines that the plurality of deciders include an additional decider, then the system may return to block 656 to process, using an additional corresponding portion of the additional ML layers of the ML model(s) associated with the additional decider, of the plurality of disparate deciders, the predicted output(s) for each of the plurality of actors to generate the further predicted output(s) for each of the plurality of actors to generate the further predicted output(s) for each of the plurality of stream and with respect to each of the plurality of actors. This process can be repeated for each of the plurality of deciders identified at block 654. If, at an iteration of block 658, the system determines that the plurality of deciders do not include an additional decider, then the system may return to block 560 of FIG. 6.

If, at an iteration of block 652, the system determines that the additional ML layers do not correspond to a plurality of disparate deciders, then the system proceeds to block 660. At block 660, the system processes, using the additional ML layers of the ML model(s), the predicted output(s) for each of the plurality of actors to generate the further predicted output(s) for each of the plurality of streams and with respect to each of the plurality of actors. In some of these implementations, the further predicted output(s) can optionally include AV control strategies or AV control commands as indicated by optional sub-block 660A. The system may then return to block 560 of FIG. 6.

Turning back to FIG. 5, at block 560, the system compares the further predicted output(s) to the corresponding ground truth label(s). The corresponding ground truth label(s) can be obtained from the past episode of locomotion at block 554. Further, the corresponding ground truth label(s) compared to the further predicted output(s) may be based on the further predicted output(s). For example, in implementations where the further predicted output(s) include predicted decisions made by a plurality of disparate deciders, then the corresponding ground truth label(s) may be ground truth decisions made by the plurality of disparate deciders during the past episode of locomotion, or defined for the past episode of locomotion. As another example, in implementations where the further predicted output(s) include corresponding predicted probability distributions associated with a plurality of disparate deciders, then the corresponding ground truth label(s) may be corresponding ground truth probability distribution associated with the plurality of disparate deciders generated during the past episode of locomotion, or defined for the past episode of locomotion. As yet another example, in implementations where the further predicted output(s) include predicted AV control strategies or predicted AV control commands, then the corresponding ground truth label(s) may be ground truth AV control strategies or ground truth AV control commands utilized during the past episode of locomotion, or defined for the past episode of locomotion.

At block 562, the system generates, based on comparing the further predicted output(s) to the corresponding ground truth label(s), one or more losses. At block 564, the system updates the additional ML layers of the ML model(s) based on one or more of the losses. The system can update the additional ML layers of the ML model(s) by, for example, backpropagating one or more of the losses across the additional ML layers of the ML model(s) to update weights of the additional ML layers of the ML model(s). In implementations that include the plurality of disparate deciders, one or more corresponding losses can be generated with respect to each of the plurality of disparate deciders, and the one or more corresponding losses can be utilized to update a corresponding portion of the additional ML layers of the ML model(s). In some versions of those implementations, a loss generated based on a resulting AV control strategy or AV control commands can be utilized in updating each of the plurality of disparate deciders.

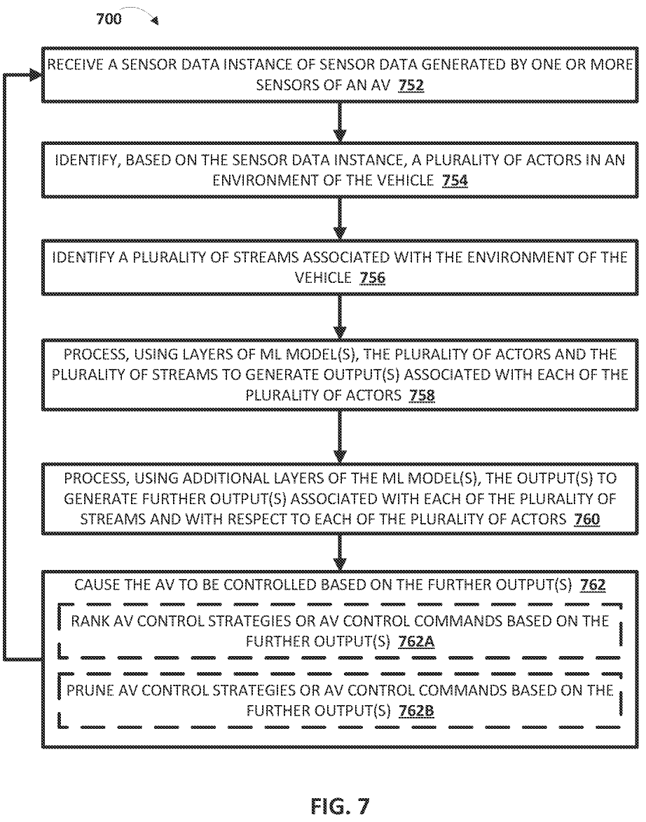

Turning now to FIG. 7, a flowchart illustrating an example method 700 of using one or more layers of one or more trained ML models and one or more additional layers of one or more ML models of FIG. 6 is depicted. For convenience, the operations of the method 700 are described with reference to a system that performs the operations. The system may include various components of various devices, including those described in FIGS. 4A, 4B, and 4C, server(s), local computing device(s) (e.g., laptop, desktop computer, and so on), other computing systems having memory and processors, Or any combination thereof. Moreover, while operations of the method 700 are shown in a particular order, this is not meant to be limiting. One or more operations, elements, or steps may be reordered, omitted, or added.

At block 752, the system receives a sensor data instance of sensor data generated by one or more sensors of an AV. The one or more sensors can include, for example, one or more of LIDAR, RADAR, camera(s), or other sensors (e.g., primary sensors 130 of FIG. 1). The sensor data can be processed to identify an environment of the AV and to detect objects in the environment of the AV. At block 754, the system identifies, based on the sensor data instance, a plurality of actors in an environment of the AV. The environment, and the plurality of actors located therein, can be identified based on the sensor data instance. For example, the environment can be identified based on processing sensor data via a localization system (e.g., localization subsystem 152 of FIG. 1). Further, each of the plurality of actors can be identified from an instance of LIDAR data generated by a LIDAR sensor, an instance of RADAR data generated by a RADAR sensor, or an instance of image data generated by vision component(s). At block 756, the system identifies a plurality of streams associated with the environment of the vehicle. The plurality of streams can be associated with the environment of the AV can identified from a previous mapping of the environment of the AV. The environment of the AV can also be identified based on the sensor data instance (e.g., based on localization of the AV via localization subsystem 152 of FIG. 1).

More particularly, in identifying the plurality of actors and the plurality of streams in the environment of the AV, the system can identify a plurality of corresponding features associated with each of the plurality of actors based on processing the sensor data. In some implementations, the plurality of features can be defined with respect to each of the plurality of actors. For example, the plurality of features associated with a given actor can include a lateral distance between the given actor and each of the plurality of streams, a lateral distance between the given actor and each of the other actors, a lateral distance between the given actor and one or more lane lines, a longitudinal distance between the given actor and each of the other actors, an absolute velocity of the given actor, a relative velocity of the given actor with respect to each of the other actors, an acceleration of the given actor, and so on. Further, the plurality of features associated with each of the other actors can include similar features, but with respect to each of the other actors. In some additional or alternative implementations, the plurality of features can be defined with respect to the AV. For example, the plurality of features associated with a given actor can include a lateral distance between the given actor and the AV, a longitudinal distance between the given actor and the AV, and a relative velocity of the given actor with respect to the AV. In some implementations, the plurality of features provides geometric information between each of the plurality of actors and the AV. The ML model can be used to leverage this geometric information to forecast candidate navigation paths of each of the actors at subsequent time instances based on the plurality of features at a given time instance.

At block 758, the system processes, and using layers of ML model(s), the plurality of actors and the plurality of streams to generate output(s) associated with each of the plurality of actor(s). In some implementations, the system can process the plurality of actors (or features thereof) and the plurality of streams using the ML model in a parallelized manner. For example, the plurality of actors (or features thereof), and the plurality of streams (or the sequence of poses corresponding thereto) can be represented as a tensor of values, and processed using the ML model.

At block 760, the system processes, using additional layers of the ML model(s), the output(s) to generate further output(s) associated with each of the plurality of streams and with respect to each of the plurality of actors. In some implementations, the further output(s) can include an AV control strategy or AV control commands that are to be utilized in controlling the AV. In other implementations, the further output(s) can include corresponding decisions made by a plurality of disparate deciders. In some additional or alternative versions of those implementations, the further output(s) can include a corresponding probability distribution associated with each decision made each of the plurality of disparate deciders.

At block 762, the system causes the AV to be controlled based on the further output(s). In implementations where the further output(s) include the AV control strategy or the AV control commands, the system can cause the AV to be controlled based on the AV control strategy or the AV control commands. In implementations where the additional ML layers correspond to the plurality of disparate deciders, block 762 may include optional sub-block 762A or optional sub-block 762B. If included, at sub-block 752A, the system ranks AV control strategies or AV control commands based on the further output(s). If included, at sub-block 762B, the system prunes AV control strategies or AV control commands based on the further output(s). The system can utilize one or more rules to prune or rank the AV control strategies or the AV control commands with respect to a list of AV control strategies or AV control commands.

Other variations will be apparent to those of ordinary skill. Therefore, the invention lies in the claims hereinafter appended.

What is claimed is:

1. A method for training one or more machine learning (“ML”) models for use by an autonomous vehicle (“AV”), the method comprising:
obtaining a plurality of actors for a past episode of locomotion of a vehicle, each of the plurality of actors corresponding to an object in an environment of the vehicle during the past episode;
obtaining a plurality of streams in the environment of the vehicle during the past episode, each of the plurality of streams representing a candidate navigation path, for the vehicle or the object corresponding to a given one of the actors, in the environment of the vehicle;
processing, using one or more ML layers of one or more of the ML models, the plurality of actors and the plurality of streams to generate predicted output for each of the plurality of actors;
processing, using one or more additional ML layers of one or more of the ML models, the predicted output for each of the plurality of actors to generate further predicted output for each of the plurality of streams and with respect to each of the plurality of actors;
generating, based on one or more reference labels for the past episode of locomotion and the further predicted output for each of the plurality of streams and with respect to each of the plurality of actors, one or more losses; and
updating, based on the one or more losses, one or more of the additional ML model layers of one or more of the ML models, wherein one or more of the additional ML model layers of one or more of the ML models are subsequently utilized in controlling the AV.

2. The method of claim 1, wherein the one or more additional layers correspond to a plurality of disparate deciders, and wherein the further predicted output comprises an associated predicted decision made by each decider, of the plurality of disparate deciders, for each of the plurality of streams and with respect to each of the plurality of actors.

3. The method of claim 2, wherein the one or more reference labels comprise an associated reference label, for each of the plurality of disparate deciders, that corresponds to a ground truth decision that is determined during the past episode of locomotion of the vehicle or that is defined for the vehicle subsequent to the past episode of locomotion of the vehicle.

4. The method of claim 3,
wherein generating one or more of the losses comprises comparing the associated predicted decision made by each of the plurality of disparate deciders to the ground truth decision, for each of the plurality of deciders, to generate one or more of the losses; and
wherein updating the one or more additional ML model layers comprises backpropagating one or more of the losses across the one or more additional ML model layers.

5. The method of any preceding claim, wherein the one or more additional layers correspond to a plurality of disparate deciders, and wherein the further predicted output comprises an associated predicted probability distribution, for each of the plurality of deciders, and for each of the plurality of streams with respect to each of the plurality of actors, that include a respective probability for a plurality of decisions associated with each of the plurality of disparate deciders.

6. The method of claim 5, wherein the one or more reference labels comprise an associated reference label, for each of the plurality of disparate deciders, that corresponds to a ground truth probability distribution that is determined during on the past episode of locomotion of the vehicle or that is defined for the vehicle subsequent to the past episode of locomotion of the vehicle.

7. The method of claim 6,
wherein generating one or more of the losses comprises comparing the associated predicted probability distribution to the ground truth probability distribution, for each of the plurality of deciders, to generate one or more of the losses; and
wherein updating the one or more additional ML model layers comprises backpropagating one or more of the losses across the one or more additional ML model layers.

8. The method of any preceding claim, wherein the further predicted output comprises a predicted vehicle control strategy or predicted vehicle control commands.

9. The method of claim 8, wherein the one or more reference labels comprise an associated reference label that corresponds to a ground truth vehicle control strategy or ground truth vehicle control commands that are determined during the past episode of locomotion of the vehicle or that is defined for the vehicle subsequent to the past episode of locomotion of the vehicle.

10. The method of claim 9,
wherein generating one or more of the losses comprises comparing the predicted vehicle control strategy or the predicted vehicle control commands to the ground truth vehicle control strategy or the ground truth vehicle control commands to generate one or more of the losses; and
wherein updating the one or more additional ML model layers comprises backpropagating one or more of the losses across the one or more additional ML model layers.

11. The method of claim 10, wherein each stream, of the plurality of streams, corresponds to a sequence of poses that represent the candidate navigation path, in the environment of the vehicle, for the vehicle or the object corresponding to a given one of the actors.

12. The method of claim 11, wherein each stream, of the plurality of streams, is at least one of:
a target stream corresponding to the candidate navigation path the vehicle will follow,
a joining stream that merges into the target stream,
a crossing stream that is transverse to the target stream,
an adjacent stream that is parallel to the target stream, or
an additional stream that is one-hop from the joining stream, the crossing stream, or the adjacent stream.

13. The method of any preceding claim, wherein the object corresponding to each of the one or more actors is at least one of: an additional vehicle that is in addition to the vehicle, a bicyclist, or a pedestrian.

14. The method of claim 13, wherein the object is dynamic in the environment of the vehicle along a particular stream of the plurality of streams.

15. The method of any preceding claim, wherein subsequently utilizing one or more of the additional ML model layers of one or more of the ML models in controlling the AV comprises:
processing, using the one or more ML model layers and the one or more additional ML model layers, sensor data generated by one or more sensors of the AV to predict an AV control strategy or predict AV control commands; and
causing the AV to be controlled based on the predicted AV control strategy or the predicted AV control commands.

16. The method of claim 15, further comprising:
ranking a plurality of AV control strategies based on the processing, wherein the predicted AV control strategy is a highest ranked AV control strategy.

17. The method of any preceding claim, wherein the one or more ML layers comprise a first portion of a given one of the one or more ML models, and wherein the one or more additional ML layers comprise a second portion of the given one of the one or more ML models.

18. The method of any one of claims 1 to 16, wherein the one or more ML layers comprise a first one of the one or more ML models, and wherein the one or more additional ML layers comprise at least a second one of the one or more ML models.

19. A method for training one or more machine learning (“ML”) models for use by an autonomous vehicle (“AV”), the method comprising:
obtaining a plurality of training instances from a past episode of locomotion of a vehicle, each of the plurality of training instances comprising:
training instance input, the training instance input comprising:
predicted output generated using one or more ML model layers of one or more of the ML models, the predicted output being generated based on a plurality of actors and a plurality of streams, each of the plurality of actors corresponding to an object in an environment of the vehicle during the past episode, and each of the plurality of streams representing a candidate navigation path in the environment of the vehicle; and
training instance output, the training instance output comprising:
one or more associated reference labels for the past episode of locomotion, each of the one or more associated reference labels corresponding to an action performed by the vehicle during the past episode of locomotion;
training one or more additional ML layers of one or more of the ML models based on the plurality of training instances, wherein one or more of the additional ML model layers of one or more of the ML models are subsequently utilized in controlling the AV.

20. A system for training one or more machine learning (“ML”) models for use by an autonomous vehicle (“AV”), the system comprising:
at least one processor; and
at least one memory storing instructions that, when executed, cause the at least one processor to:
obtain a plurality of actors for a past episode of locomotion of a vehicle, each of the plurality of actors corresponding to an object in an environment of the vehicle during the past episode;
obtain a plurality of streams in the environment of the vehicle during the past episode, each of the plurality of streams representing a candidate navigation path, for the vehicle or the object corresponding to a given one of the actors, in the environment of the vehicle;
process, using one or more ML layers of one or more of the ML models, the plurality of actors and the plurality of streams to generate predicted output for each of the plurality of actors;
process, using one or more additional ML layers of one or more of the ML models, the predicted output for each of the plurality of actors to generate further predicted output for each of the plurality of streams and with respect to each of the plurality of actors;
generate, based on one or more reference labels for the past episode of locomotion and the further predicted output for each of the plurality of streams and with respect to each of the plurality of actors, one or more losses; and
update, based on the one or more losses, one or more of the additional ML model layers of one or more of the ML models, wherein one or more of the additional ML model layers of one or more of the ML models are subsequently utilized in controlling the AV.
